(19) United States
(12) Patent Application Publication
(10) Pub. No.: US 2022/0094532 A1
(43) Pub. Date: Mar. 24, 2022

(54) METHODS AND SYSTEMS FOR HOMOMORPHIC DATA REPRESENTATION AND CONCEALMENT POWERED BY CLIFFORD GEOMETRIC ALGEBRA

(71) Applicant: X-Logos, LLC, Colorado Springs, CO (US)

(72) Inventors: David W. Honorio Araujo da Silva, Colorado Springs, CO (US); Marcelo Araujo Xavier, Dearborn, MI (US); Carlos A. Paz de Araujo, Colorado Springs, CO (US)

(73) Assignee: X-Logos, LLC, Colorado Springs, CO (US)

(21) Appl. No.: 17/366,019

(22) Filed: Jul. 1, 2021

Related U.S. Application Data
(60) Provisional application No. 63/046,943, filed on Jul. 1, 2020.
(60) Provisional application No. 63/046,954, filed on Jul. 1, 2020.

(51) Int. Cl. H04L 9/08; H04L 9/30; G06F 17/16

(52) U.S. Cl. CPC H04L 9/0825; G06F 17/16; H04L 9/3066; H04L 9/085

(57) ABSTRACT

Disclosed are methods and systems to conceal (encrypt) & recover (decrypt) a data message using Geometric Algebra using Modular Concealment (MC) between a first computing device and a second computing device over a network communication connection. The security key(s), message data, and ciphertext are all represented as Geometric Algebra multivectors. The MC concealment provides for both additive and multiplicative homomorphism. Further data representations are presented for multivector packing schemes including Clifford Eigenvalue Packing (CEP) and Complex Magnitude Squared Packing (CMSP). The CEP and CMSP data representations also provide support for additive and multiplicative homomorphism. To assist in security key exchange, a key exchange protocol is also presented for the creation and transfer of security key multivectors.

### CROSS REFERENCE TO RELATED APPLICATIONS

This application is based upon and claims the benefit of U.S. provisional application Ser. No. 63/046,943, filed Jul. 1, 2020, entitled “Homomorphic Data Concealment Powered By Clifford Geometric Algebra,” and Ser. No. 63/046,954, filed Jul. 1, 2020, entitled “Experiments with Clifford Algebra Applied to Cryptography;” all of which are also specifically incorporated herein by reference for all that they disclose and teach.

### BACKGROUND OF THE INVENTION

In the last several decades, personal computers and other consumer computing devices, such has hand-held devices and smart phones, have become ubiquitous among the general public. As the proliferation of personal computers and other computing devices became prevalent, the usefulness of the computers and other computing devices was increased by interconnected communications between different computers/computing devices via various electronic networking communications systems. With the advent of the publicly accessible Internet and the establishment of the World Wide Web (WWW) for common communications between computers and/or other computing devices on the Internet, it became common for private identification and financial information to be transferred over the publicly accessible Internet. To ensure that the private information is not accessed by parties that are not intended to be privy to the private information, various concealment/encryption techniques have been applied to the private data being transferred over the Internet. As data storage has become accessible over networking technologies, including over the publicly accessible Internet, it has also become prudent to store sensitive data in a concealed/encrypted format.

Modem concealment/encryption employs mathematical techniques that manipulate positive integers or binary bits. Asymmetric concealment/encryption, such as RSA (Rivest-Shamir-Adleman), relies on number theoretic one-way functions that are predictably difficult to factor and can be made more difficult with an ever-increasing size of the encryption keys. Symmetric encryption, such as DES (Data Encryption Standard) and AES (Advanced Encryption Standard), uses bit manipulations within registers to shuffle the concealed text/cryptotext to increase “diffusion” as well as register-based operations with a shared key to increase “confusion.” Diffusion and confusion are measures for the increase in statistical entropy on the data payload being transmitted. The concepts of diffusion and confusion in encryption are normally attributed as first being identified by Claude Shannon in the 1940s. Diffusion is generally thought of as complicating the mathematical process of generating unencrypted (plain text) data from the encrypted (cryptotext) data, thus, making it difficult to discover the encryption key of the concealment/encryption process by spreading the influence of each piece of the unencrypted (plain) data across several pieces of the concealed/encrypted (cryptotext) data. Consequently, an encryption system that has a high degree of diffusion will typically change several characters of the concealed/encrypted (cryptotext) data for the change of a single character in the unencrypted (plain) data making it difficult for an attacker to identify changes in the unencrypted (plain) data. Confusion is generally thought of as obscuring the relationship between the unencrypted (plain) data and the concealed/encrypted (cryptotext) data.

Accordingly, a concealment/encryption system that has a high degree of confusion would entail a process that drastically changes the unencrypted (plain) data into the concealed/encrypted (cryptotext) data in a way that, even when an attacker knows the operation of the concealment/encryption method (such as the public standards of RSA, DES, and/or AES), it is still difficult to deduce the encryption key.

Homomorphic Encryption is a form of encryption that allows computations to be carried out on concealed cipher text as it is concealed/encrypted without decrypting the cipher text that generates a concealed/encrypted result which, when decrypted, matches the result of operations performed on the unencrypted plaintext.

The word homomorphism comes from the ancient Greek language: óμóç(homos) meaning “same” and μoρφ\acute{η} (morphe) meaning “form” or “shape.” Homomorphism may have different definitions depending on the field of use. In mathematics, for example, homomorphism may be considered a transformation of a first set into a second set where the relationship between the elements of the first set are preserved in the relationship of the elements of the second set.

For instance, a map ƒ between sets A and B is a homomorphism of A into B if

ƒ(a₁opa₂)=ƒ(a₁)opƒ(a₂)|a₁,a₂∈A

where “op” is the respective group operation defining the relationship between A and B.

More specifically, for abstract algebra, the term homomorphism may be a structure-preserving map between two algebraic structures such as groups, rings, or vector spaces. Isomorphisms, automorphisms, and endomorphisms are typically considered special types of homomorphisms. Among other more specific definitions of homomorphism, algebra homomorphism may be considered a homomorphism that preserves the algebra structure between two sets.

### SUMMARY OF THE INVENTION

An embodiment of the present invention may comprise a method for concealing a message multivector (M̅) with Modular Concealment (MC) utilizing a secret key comprised of two secret key multivectors (K̅₁,K̅₂) and a random multivector (R) transferred between a first device and a second device wherein the multivectors are members of a 3-dimensional Geometric Algebra product space ( [symbol] ³), the multivectors are invertible, and the two secret key multivectors (K̅₁,K̅₂) are known to both the first and second devices, the method comprising: computing by a first device a concealed multivector (C̅) as a Geometric Algebra product operation of the random multivector (R̅), the first multivector (R₁) and the second multivector (K̅₂) added to the message multivector (M̅) (C̅=R̅K̅₁K̅₂+M̅); transferring by the first device the concealed multivector (C̅) to the second device; and, computing by the second device a recovery of the concealed multivector (C̅) back into the message multivector (M̅) as a modulus operation on the concealed multivector (C̅) of the Geometric Algebra product operation of the first multivector (K̅₁) and the second multivector (K̅₂) (M̅=C̅ mod(K̅₁K̅₂)).

An embodiment of the present invention may further comprise a data concealment system for concealment of a message multivector (M̅) with Modular Concealment (MC) utilizing a secret key comprised of two secret key multivectors (K̅₁,K̅₂) and a random multivector (R) that is transferred between a first device and a second device wherein the multivectors are members of a 3-dimensional Geometric Algebra product space ( [symbol] ³), the multivectors are invertible, and the two secret key multivectors (K̅₁,K̅₂) are known to both the first and second devices, the method comprising: the first device, wherein the first device further comprises: a concealed multivector computation subsystem that computes a concealed multivector (C̅) as a Geometric Algebra product operation of the random multivector (R̅), the first multivector (K̅₁) and the second multivector (K̅₂) added to the message multivector (M̅) (C̅=R̅K̅₁K̅₂+M̅); and a conceal multivector transfer subsystem that transfers the concealed multivector (C̅) to the second device; and the second device, wherein the second device further comprises: a message multivector recovery computation subsystem that computes a recovery of the concealed multivector (C̅) back into the message multivector (M̅) as a modulus operation on the concealed multivector (C̅) of the Geometric Algebra product operation of the first multivector (K̅₁) and the second multivector (K̅₂) (M̅=C̅ mod(K̅₁K̅₂)).

### BRIEF DESCRIPTION OF THE DRAWINGS

In the drawings,

FIG. 1 is a block diagram of the hardware implementation for a data concealment embodiment.

FIG. 2 is a flow chart a concealing and recovery operation for an embodiment.

FIG. 3 is a flow chart of Clifford eigenvalue multivector packing operation for an embodiment.

FIG. 4 is a flow chart of complex magnitude squared multivector packing operation for an embodiment.

FIG. 5 is a flow chart of key exchange operation for an embodiment.

### DETAILED DESCRIPTION OF THE EMBODIMENTS

General-purpose methods are proposed for data representation and data concealment via multivector decompositions and a small subset of functions in the three-dimensional Clifford Geometric Algebra. Mechanisms are demonstrated that can be explored for purposes from plain data manipulation to homomorphic data processing with multivectors. The wide variety of algebraic representations in Clifford Geometric Algebra allow us to explore concepts from integer, complex, vector and matrix arithmetic within a single, compact, flexible and yet powerful algebraic structure in order to propose novel homomorphisms. The constructions can be incorporated into existing applications as add-ons as well as used to provide standalone data-centric algorithms.

The digital representation of information creates opportunities as well as challenges given that not everyone should create, access and/or modify data in the same way to avoid violations of ownership and further forms of tampering. As a response to this problem, there are several different data protective techniques, including cryptography, steganography, data masking, data obfuscation, data encoding, data convolution, and data hiding. These technologies have several overlaps, differing however at the application level. With so many different terminologies and sets of rules to define distinct protective data-access techniques, we find it important to treat them as classes of a general-purpose data protection mechanism, which in this document we refer to as data concealment.

Clifford geometric algebra is known by the richness, robustness and flexibility of its algebraic structure, which allows us to take advantage of concepts from several different branches of mathematics such as vector and matrix spaces, integer, rational and complex arithmetic, all in a single compact system.

An embodiment may advantageously utilize Geometric Algebra to provide the concealment (encryption) and recovery (decryption) of numeric messages that may be transmitted through, and possibly have operations performed by, an intermediary computing system (e.g., the broad-based computing system currently, and commonly, referred to as the Cloud, or cloud computing). The use of Clifford Geometric Algebra (aka. Geometric Algebra) to provide the encryption and decryption provides the mathematical basis for the homomorphic operations of an embodiment.

Geometric Algebra is an area of mathematics that describes the geometric interaction of vectors and other objects in a context intended to mathematically represent physical interactions of objects in the physical world. As used herein, this area of mathematics encompasses Geometric Algebra, Conformal Geometric Algebra and Clifford Algebra (referred to collectively herein as “Geometric Algebra”). Generally, Geometric Algebra defines the operations, such as geometric product, inverses and identities, which facilitate many features of the various embodiments disclosed herein. Further, Geometric Algebra allows for the organization and representation of data into the “payload” of a multivector where the data in the payload may represent, for example, plaintext, ciphertext, or identifying signatures. Consequently, the various embodiments make beneficial use of Geometric Algebra properties to provide concealment/encryption, recovery/decryption, and intermediary homomorphic operations in a relatively computationally simplistic manner while still providing robust security for both data in motion and data at rest (e.g., data stored in the Cloud).

It may be demonstrated that through multivector decompositions and a small subset of operations in the Clifford Geometric algebra (sometimes also referred to as GA for simplicity) it is possible to propose new methods for general-purpose data representation and data concealment with multivectors through processes referred to, herein, as multivector packing schemes and concealment schemes, respectively. The methods of the various embodiments may be used as part of the necessary reconciliation of data availability and privacy preservation. This is important because once data is concealed, one cannot meaningfully process it, unless the concealment function is homomorphic with respect to one or more operations. Therefore. homomorphism is a key concern in constructions of the various embodiments since there is particular interest in packing and concealment schemes that allow homomorphic computations over concealed data.

An embodiment that conceals/encrypts and recovers/decrypts messages using Geometric Algebra may utilize the intrinsic algebraic homomorphic properties of Geometric Algebra to permit arithmetic operations on encrypted messages handled by an intermediary computing system without the need for the intermediary computing system to decrypt the concealed/encrypted messages prior to performing the arithmetic operations. Accordingly, the intermediary computing system does not need to know any information regarding any of the secret security keys of the concealment-encryption/decryption processes to properly perform the arithmetic operations. The concealed/encrypted results of the arithmetic operations performed by the intermediary computing system, when decrypted at a destination computing device, produce results equivalent to the same operations as if the operations were performed on the unencrypted plain text messages. An embodiment may provide the homomorphic properties as a product of algebraic homomorphism without the need to use additional methods, such as “bootstrapping” (e.g., performing a recursive operation to reduce the noise associated with a cipher text) to achieve the homomorphic properties.

1. Preliminaries

The various embodiments may be comprised of functional blocks, each of which may be tailored as described in more detail below according to objectives for scope, capability and security. The following sections provide a mathematical and numerical description of these functional blocks.

A central feature of the various embodiments is the use of Geometric Algebra. Geometric Algebra as used herein is an area of mathematics that encompasses Geometric Algebra, Conformal Geometric Algebra and Clifford Algebra (collectively herein, “Geometric Algebra”). Geometric Algebra allows for the organization and representation of data into the “payload” of a multivector where the data may be plaintext, ciphertext, or signatures, for example. Geometric Algebra defines the operations, such as geometric product, inverses and identities, which are enablers of concealment/recovery and data representation calculations of the various embodiments.

Multivectors are simply the additive combination of a scalar, a vector, a bivector and so forth up to an n-dimension vector. However, the unit vectors follow the algebraic structure of quaternions (Hamilton) and non-commutative algebra (Grassman). These two types of algebra allowed Clifford to conceive of the Geometric Product which is used by the various embodiments as one of the “primitive” functions of the embodiments.

Multivectors are denoted by a capital letter with an overbar (M̅) in order to provide a quick and easy distinction of a multivector object and any other data structure. The unit basis vectors are denoted as (ēᵢ) as it is desired that the reader visually and quickly separate the computable coefficients from their bases. In the constructions the Clifford signature [symbol] (3, 0) is used, however, herein, elements generated in [symbol] (3, 0) are referred to as members of a geometric product space that we denote as [symbol] ³. Datum that is to be represented and concealed is referred to as a message. The multivector that represents a message is referred to as a message multivector.

We denote the length in bits of an integer n as |n|_{bits}. The rounding (floor or ceiling operations, whichever is closer to an integer) of the division of two integers x and y is denoted by w=[x/y] where w∈ [symbol] . We denote x mod y but the much shorter |x|_{y}. We write a floor division of x by y mod z as └x/y┘_{z}.

2. Basics of Clifford Geometric Algebra (3.0)

Multivectors in [symbol] (3, 0) are members of the 3-dimensional geometric product space, denoted herein by [symbol] ³. For all M̅∈ [symbol] ³, a multivector is given by M̅=m₀ē₀+m₁ē₁+m₂ē₂+m₃ē₃+m₁₂ē₁₂+m₁₃ē₁₃+m₂₃ē₂₃+m₁₂₃ē₂₃. Herein, the four grades of a multivector are referred to as the scalar part [symbol] M̅ [symbol] ₀=m₀ē₀, the vector part [symbol] M̅ [symbol] ₁=m₁ē₁+m₂ē₂+m₃ē₃, the bivector part [symbol] M̅ [symbol] ₂=m₁₂ē₁₂+m₁₃ē₁₃+m₂₃ē₂₃, and the trivector or pseudoscalar part [symbol] M̅ [symbol] 3=m₁₂₃ē₁₂₃, such that the multivector may be rewritten as M̅=Σᵢ₌₀³ [symbol] M̅ [symbol] ᵢ.

An example of a three-dimension (3D) multivector Ā that includes a scalar, a vector, a bivector, and a trivector is:

Ā=a₀+a₁ē₁+a₂ē₂+a₃ē₃+a₁₂ē₁₂+a₁₃ē₁₃+a₂₃ē₂₃+a₁₂₃ē₁₂₃

where ēᵢ is a unit vector along the i-axis and ē₁₂ represents the orientation of the area created by a₁₂. Notably, a Geometric Algebra multivector in N-space (i.e., a N-dimension multivector) has 2^{N} coefficients whereas a standard N-dimension vector has only N coefficients. Accordingly, the Geometric Algebra multivectors provide a sense of size, direction, and volume while a standard vector would only provide a sense of size and direction. As the concepts involved in Geometric Algebra are part of a deep and rich mathematical file, some general observations may be helpful to the description of the various embodiments disclosed herein, below. First, each of the aᵢ values in the multivector Ā above may be “packed” with information and each aᵢ value may range from zero to very large (e.g., >256,000 bits or an entire message). Secondly, the inverse of Ā when multiplied by Ā yields unity, or:

ĀĀ⁻¹=1

Thus, if a second multivector B̅ is created and the geometric product ĀB̅ is transmitted, then the destination can recover B̅ through:

ĀĀ⁻¹B̅=B̅

As for the basic operations in [symbol] ³, similar to the operations of a vector space, one can add, subtract, scalar multiply and scalar divide multivectors component-wise. Multiplication of multivectors is achieved with the geometric product, the fundamental operation in [symbol] ³ which is given by ĀB̅=Ā·B̅+Ā\hat{ }B̅, where Ā·B̅ is the Clifford dot product and Ā\hat{ }B̅ is the Clifford wedge product. The various embodiments frequently make use of the fact that the subspace spanned by {ē₀, ē₁₂₃} is closed under the geometric product, since (ē₀)²=ē₀ and (e₁₂₃)²=−ē₀. Thus, the trivector part [symbol] M̅ [symbol] ₃ is commonly referred to as a pseudoscalar, since ē₁₂₃ behaves as the complex number i=\sqrt{−1}. Accordingly, when a multivector is comprised only of scalar and trivector parts (i.e., M̅=m₀ē₀+m₁₂₃ē₁₂₃), herein, it is written M̅∈ [symbol] , treated as the complex scalar m₀+m₁₂₃i, and the geometric product and the scalar product are used interchangeably.

A multivector involution is an operation that changes the signs of specific unit basis vectors of a given multivector. Herein, the document makes use of the following involutions:
Clifford conjugation: M̅= [symbol] M̅ [symbol] ₀− [symbol] M̅ [symbol] ₁− [symbol] M̅ [symbol] ₂+ [symbol] M̅ [symbol] ₃=Σᵢ₌₀³ [symbol] M̅ [symbol] ᵢ(−1)^{i+└i/2┘}
Reverse: M̅^{†}= [symbol] M̅ [symbol] ₀− [symbol] M̅ [symbol] ₁+ [symbol] M̅ [symbol] ₂− [symbol] M̅ [symbol] ₃=Σᵢ₌₀³ [symbol] M̅ [symbol] ᵢ(−1)^{└i/2┘}

Note that for all M̅∈ [symbol] ³, it holds that M̅M̅∈ [symbol] . Furthermore, if M̅∈ [symbol] , then the Reverse is identical to the complex conjugate: M̅^{†}=m₀ē₀−m₁₂₃ē₁₂₃. The following Definitions are also useful.

Definition 1. If M̅M̅·0, the inverse of M̅ is given by

$${\overline{M}}^{- 1} = \overline{M} \text{/} ( \overline{M} \overline{\overline{M}} ) = \frac{{\overline{\overline{M}} ( \overline{M} \overline{\overline{M}} )}^{†}}{R ( \overline{M} )}$$

(see Definition 2 below for a description of the rationalize R(M̅)).

An alternative method of computing the inverse of a multivector relies on a complex numbers technique and uses the following definition:

Definition 2. The rationalize of M̅, denoted by R(M̅), is given by R(M̅)=(M̅M̅)(M̅M̅)^{†}. It always holds that R(M̅)∈ [symbol] .

Definition 3. The inverse of M̅∈ [symbol] ³ in terms of its rationalize is given by M̅⁻¹=M̅(M̅M̅)^{†}R(M̅)⁻¹ such that M̅M̅⁻¹=1.

Another topic of interest in the various embodiments' GA-based framework is eigenvalue computation in Clifford geometric algebra. Multivector M̅ is said to have eigenvalue α∈ [symbol] associated with eigenelement X̅∈ [symbol] ³ if a and X̅ satisfy the equation M̅X̅=αX̅. Every multivector M̅∈ [symbol] ³ such that M̅≠0 has two (not necessarily distinct) eigenvalues.

A summary of the results of computing the eigenvalues of a multivector are shown in Proposition 1 and Theorem 1 below.

Proposition 1. A multivector M̅∈ [symbol] ³ can be written in terms of the multivectors Z̅ and F̅ such that M̅=Z̅+F̅ where Z̅=½(M̅+M̅) and F̅=½(M̅−M̅), for Z̅ is a complex scalar in the form of Z̅= [symbol] M̅ [symbol] ₀+ [symbol] M̅ [symbol] ₃, and F̅= [symbol] M̅ [symbol] ₁+ [symbol] M̅ [symbol] ₂.

Proof. Given M̅= [symbol] M̅ [symbol] ₀+ [symbol] M̅ [symbol] ₁+ [symbol] M̅ [symbol] ₂+ [symbol] M̅ [symbol] ₃ and M̅= [symbol] M̅ [symbol] ₀− [symbol] M̅ [symbol] ₁− [symbol] M̅ [symbol] ₂+ [symbol] M̅ [symbol] ₃, then M̅+M̅=2( [symbol] M̅ [symbol] ₀+ [symbol] M̅ [symbol] ₃)=2Z̅. Therefore, Z̅=½(M̅+M̅). Similarly, M̅−M̅=2( [symbol] M̅ [symbol] ₁+ [symbol] M̅ [symbol] ₂)=2F̅, and therefore F̅=½(M̅−M̅).

Theorem 1. The eigenvalues α₁, α₁∈ [symbol] of a multivector M̅∈ [symbol] ³ are computed as αᵢ=Z̅±\sqrt{Z̅²−M̅M̅}=Z±\sqrt{F̅²}, i=1 for +, 2 for −.

Proof We know that M̅= [symbol] M̅ [symbol] ₀− [symbol] M̅ [symbol] ₁− [symbol] M̅ [symbol] ₂+ [symbol] M̅ [symbol] ₃, which can be rewritten as [symbol] M̅ [symbol] ₀+ [symbol] M̅ [symbol] ₃−( [symbol] M̅ [symbol] ₁+ [symbol] M̅ [symbol] ₂), and therefore M̅=Z̅−F̅. Hence, M̅M̅=(Z̅+F̅)(Z̅−F̅)=Z̅²−Z̅F̅+F̅Z̅−F̅². Since Z̅ is a commuting complex scalar, then Z̅F̅ and F̅Z̅ commutes, so we can write M̅M̅=Z̅²−F̅². In order to compute the eigenvalues of a multivector M̅, we need to solve for α in the characteristic equation M̅X̅=αX̅, α∈ [symbol] . We write (M̅−α)X̅=0. The determinant of a multivector M̅, resulting in a complex scalar, is computed as det(M̅)=M̅M̅. Thus, we write det(M̅−α)=0, then det(M̅−α)=(M̅−α)(M̅−α)=0. For simplicity, let N̅=(M̅−α), where we want to satisfy N̅N̅=0. Let Z̅_{N}, Z̅_{M}, Z̅_{α}, F̅_{N}, F̅_{M}, and F̅_{α}, be the Z̅-type and the F̅-type multivectors computed for N̅, Z̅, and α, respectively. Then we can write N̅N̅=Z̅_{N}²−F̅_{N}², which can be expressed as (Z̅_{α}+Z̅_{M})²−(F̅_{α}+F̅_{M})²=0. Since Z̅_{α} is the complex-like part of α∈ [symbol] , then Z̅_{α}=α and we can write (α+Z̅_{M})²−F̅_{M}²=0. By expanding the terms, we obtain α+2αZ̅_{M}+Z̅_{M}²−F̅_{M}²=0. Since we now only have multivectors in terms of M̅, we let Z̅_{M}=Z̅ and M̅M̅=Z̅_{M}²−F̅² so we can write α²+2αZ̅+M̅M̅=0. In order to solve for α, we finally arrive at α=Z̅±\sqrt{Z̅²−M̅M̅}=Z̅±\sqrt{F̅²}.

2.1 Homomorphisms

Given two messages a, b∈Z, a function ƒ is homomorphic with respect to a given operation ∘ if ƒ(a∘b)=ƒ(a)∘ƒ(b). When we represent the messages a, b as the multivectors Ā,B̅∈ [symbol] ³, we say that the function of this representation will be homomorphic with respect to ∘ if ƒ(Ā∘B̅)=ƒ(Ā)∘ƒ(B̅). The two operations of interest are addition and multiplication. Addition of multivectors is achieved element-wise. Multiplication of multivectors is achieved via the geometric product. Thus, when we say that a given function of multivectors is homomorphic with respect to multiplication, in the context of multivector packing and concealment schemes, we mean that the geometric product of multivectors that represent scalars is equivalent to the standard multiplication of the scalars.

Definition 4. Let K be an arbitrary space, let ƒ: [symbol] → [symbol] , and let operation ∘ be a binary operation ∘: [symbol] × [symbol] → [symbol] . Function ƒ is said to be homomorphic with respect to ∘ if ƒ(a∘b)=ƒ(a)∘ƒ(b) for all a,b∈ [symbol] .

We are interested in functions that are additive homomorphic, multiplicative homomorphic, or both.

Homomorphic concealment/encryption is a form of concealment/encryption that allows computations to be carried out on cipher text as it is encrypted without decrypting the cipher text that generates a concealed/encrypted result which, when decrypted, matches the result of operations performed on the unencrypted plaintext.

The essential purpose of homomorphic concealment/encryption is to allow computation on concealed/encrypted data without decrypting the data in order to perform the computation. In this way, the concealed/encrypted data can remain confidential and secure while the concealed/encrypted data is processed for the desired computation. Accordingly, useful tasks may be accomplished on concealed/encrypted (i.e., confidential and secure) data residing in untrusted environments. In a world of distributed computation and heterogeneous networking, the ability to perform computations on concealed/encrypted data may be a highly desirable capability. Hence, finding a general method for computing on encrypted data is likely a highly desirable goal for cryptography.

The most sought-after application of homomorphic encryption may be for cloud computing. Data that is stored in the Cloud is typically not encrypted, and the breach of the Cloud stored, unencrypted data is ranked by the Cloud Security Alliance as the number one threat to data security. Concealing/Encrypting Cloud stored data may mitigate the threat of data being compromised by a breach, but then the remote clients (owners of the data) would not then be able to perform operations (i.e., add, multiply, etc.) on the Cloud stored data while the data remains in the Cloud. In order to perform operations on concealed/encrypted data stored in the Cloud, it would be necessary to download the concealed/encrypted Cloud stored data, recover/decrypt the data, perform all desired operations on the data locally, conceal/encrypt the resulting data and send the resulting data back to the Cloud. Alternatively, if a user wants the Cloud services provider to perform the computations, the Cloud would require access to the user's encryption/security keys. It is becoming increasing undesirable to provide the Cloud access to a user's security keys as the more entities that have access to the security keys inherently increases the susceptibility of the security keys to being breached, or even stolen by an unscrupulous provider. Homomorphic concealment/encryption would allow the Cloud to operate on client data without decryption, and without access to the client's security keys.

The concealed/encrypted data values may be stored on the intermediary computing system until such time that particular arithmetic operations are desired by a user, then the intermediary computing system may perform the desired arithmetic operations using the cipher text data stored at the intermediary computing system. Likewise, the concealed/encrypted data values may be immediately operated on by the intermediary computing system as soon as the subject concealed/encrypted data values are received by the intermediary computing system. However, as one skilled in the art will recognize, the process of receiving the concealed/encrypted data values at the intermediary computing system inherently includes storing the encrypted data values at the intermediary computing system even if only fleetingly in an immediately used and erased Random Access Memory (RAM) location or operational register location of a computational subsystem of the intermediary computing system.

For the various embodiments, the “payload” may be packed in the values of the scalars and coefficients of the multivector elements. The packing method may define, among many things, the Geometric Algebra operations permissible for an embodiment. For example, the Rationalize operation on multivectors yields zero when all multivector coefficients are equal. Such multivectors having all equal coefficients have no inverse and the geometric product of such multivectors having all equal coefficients with another multivector has no inverse. Different aspects of the various embodiments, including the decryption methodology that utilizes the inverse of the security key(s) multivector to perform the decryption. Therefore, to avoid problems when performing an inverse operation, the various multivectors being utilized in the various embodiments should not have all equal value coefficients, unless specifically identified as being meant to be non-invertible.

3 Multivector Packing Schemes

Before discussing details of different methods, we propose to represent data, we introduce Definition 5 as a general definition of what is a multivector packing.

Definition 5. Given a function ƒ: [symbol] ³→ [symbol] , a Multivector Packing Scheme is a probabilistic polynomial-time computable function g: [symbol] → [symbol] ³ such that for all m∈ [symbol] , ƒ(g (m))=m.

3.1 Clifford Eigenvalue Packing (CEP) Scheme

Definition 6. CEP Forward Mapping (M̅=\vec{CEP}(m)) Given a message m∈ [symbol] and a random number r uniformly selected from {m, . . . , b−1}, for an arbitrary boundary b, where r>m, and pre-defined auxiliary multivector Ā∈ [symbol] ³ such that R(Ā)≠0 and therefore ĀĀ⁻¹=0, a message multivector M̅∈ [symbol] ³ is computed as follows: let d₀=½(r+m) and d₂=½(r−m) so the multivector M̅∈ [symbol] ³ is defined as:

D̅=d₀ē₀+0ē₁+d₂ē₂+0ē₃+0ē₁₂+0ē₁₃+0ē₂₃+0ē₁₂₃ Eq. 1:

### Then M̅=ĀD̅Ā⁻¹.

Remark 1. Since a packing scheme is not meant to hide information, A does not need to be secret. Ā can be generated as a system variable and be globally available to the application where the CEP is being implemented and used.

Definition 7. CEP Backward Mapping (m= [symbol] (M̅)) Given a message multivector M̅∈ [symbol] ³, a message m∈ [symbol] is computed such that m=Z̅−\sqrt{Z̅²−M̅M̅}=Z̅−\sqrt{F̅²}.

Theorem 2. Correctness of CEP If m∈ [symbol] , it holds that [symbol] (\vec{CEP}(m))=m.

Proof Given a multivector M̅ generated according to Definition 6, we know that D̅ does not have a pseudoscalar, thus, Z̅ and F̅² from M̅ are integers and thus commute. Since F̅² is just an integer, the scalar part of Ā is cancelled in ĀD̅Ā⁻¹ thus F̅²=d₂². We also know that Z̅=d₀. According to Definition 6 we know that we recover m as follows:

Z̅−\sqrt{F̅²}=d₀−d₂=m Eq. 2

Definition 8. Alternative CEP Backward Mapping Since Ā is known, an alternative CEP Backward Mapping is computed as follows:

m=d₀−d₂,D̅=Ā⁻¹M̅Ā Eq. 3

Remark 2. The CEP is a packing scheme that leverages the function that computes the eigenvalue of a multivector. Since this function is both additive and multiplicative homomorphic, the packing scheme is also homomorphic with respect to addition and multiplication, i.e., CEP(Ā∘B̅)=CEP(Ā)∘CEP(B̅),∘∈(+,·).

3.2 Complex Magnitude Squared Packing (CMSP) Scheme

For this packing scheme, we select two coefficients of M̅ to be computed in such way that R(M̅)=m. We take advantage of how the coefficients m₀ and m₁ of the multivector M̅ are involved in the computation of R(M̅) and, therefore, we defined them in terms of a complex number z=a+bi, where |z²|=a²+b².

Due to the lengthy aspect of the final solution, we break it down into auxiliary equations, which are shown in Definition 9. For computing m₀ and m₁, let

τ=b²−4bm₂m₁₃+4bm₃m₁₂+4m₂²m₁₃²+4m₂²m₂₃²

μ=−4m₂²m₁₂₃²−8m₂m₃m₁₂m₁₃+4m₃²m₁₂²+4m₃²m₂₃²−4m₃²m₁₂₃²

ν=−4m₁₂²m₂₃²+4m₁₂²m₁₂₃²−4m₁₃²m₂₃²+4m₁₃²m₁₂₃²−4m₂₃⁴

ω=8m₂₃²m₁₂₃²+4am₂₃²−4m₁₂₃⁴−4am₁₂₃⁴ Eq. 4

Definition 9. Auxiliary Equations for m₀ and m₁ Let x₁ . . . x₆ be auxiliary equations for m₀ and x₇ . . . x₉ be auxiliary equations for m₁ such that:

x₁=(b−2m₂m₁₃+2m₃m₁₂)/(2m₁₂₃)

x₂=m₂₃

x₃=bm₂₃

x₄=2m₁₂₃

x₅=(τ+μ+ν+ω)

x₆=(−2m₂m₁₃m₂₃+2m₃m₁₂m₂₃)

x₇=(2m₁₂₃(m₂₃+m₁₂₃)(m₂₃−m₁₂₃))

x₈=(2(m₂₃+m₁₂₃)(m₂₃−m₁₂₃)) Eq. 5

Definition 10. CMSP Forward Mapping (M̅=\vec{CMSP}(m)) Given a message m∈ [symbol] , we let m to be expressed as the magnitude squared of a complex number z=a+bi such that m=|z|²=a²+b². We first define the coefficients a and b of z as follows: let a be a random number in Z and b=\sqrt{m−a²}. The message multivector M̅ is computed such that M̅M̅=z. Let the coefficients from m₂ to m₁₂₃ be random numbers in [symbol] . We compute m₀ and m₁ such that m₀=x₁−(x₂(x₃+x₄\sqrt{x₅}+x₆))/x₇ and m₁=−(x₃+x₄\sqrt{x₅}+x₆)/x₈.

Theorem 3. The operation M̅M̅ produces a complex scalar. The multiplication of this complex scalar with its own reverse results in the magnitude squared.

Proof. The Clifford conjugation of a multivector M̅ changes the sign of the vector and the bivector part of M̅. The geometric product of M̅ and its Clifford conjugation M̅ cancels the vector and bivector parts, i.e., [symbol] M̅M̅ [symbol] ₁= [symbol] M̅M̅ [symbol] ₂=0, resulting in a multivector consisting of only its scalar and pseudoscalar parts: M̅M̅= [symbol] M̅M̅ [symbol] ₀+ [symbol] M̅M̅ [symbol] ₃. The reverse of a multivector M̅ changes the sign of the vector and trivector (pseudoscalar) parts. The reverse of M̅M̅ will change the sign of [symbol] M̅M̅ [symbol] ₃, which is equivalent to performing the complex conjugation operation on the complex scalar. The product of a complex number and its conjugate results in the magnitude squared of that complex number. From Definition 2 we recall that the rationalize is computed as RM̅=(M̅M̅)(M̅M̅)^{†}, where (M̅M̅) results in a complex scalar and (M̅M̅)^{†} is the complex conjugate. The CMSP packs a multivector M̅ such that M̅M̅∈C, where the rationalize computes the magnitude squared of the complex scalar M̅M̅.

Definition 11. CMSP Backward Mapping ((m= [symbol] (M̅)) Given a message multivector M̅∈ [symbol] ³, a message m∈ [symbol] is computed such that R(M̅)=m.

Theorem 4. Correctness of CMSP For all m∈ [symbol] and all M̅∈ [symbol] ³ that are outputted by \vec{CMSP}(m), the following holds: [symbol] (\vec{CMSP}(m))=m.

Remark 3. The proof of correctness for the CMSP is too long for this manuscript. Instead, we provide a high-level overview of the proof. Given a message m, we compute a complex number z=a+bi by allowing a to be a random integer and b=\sqrt{m−a²} such that |z|²=m. We then build a multivector M̅ such that [symbol] M̅M̅ [symbol] ₀=a and [symbol] M̅M̅ [symbol] ₃=b. Therefore, it is clear that R(M̅)=m since the rationalize is the product of the complex scalar M̅M̅ by its complex conjugate (M̅M̅)^{†}, which is the magnitude square of a complex number. The proof then depends on the correctness of the auxiliary functions in Definition 9. If those equations are correct, then the CMSP is also correct.

Remark 4. The rationalize of a multivector, similarly to the complex magnitude square of a complex number, is multiplicative homomorphic, i.e., R(ĀB̅)=R(Ā)R(B̅). Hence, \vec{CMSP}(ĀB̅)=\vec{CMSP}(Ā)\vec{CMSP}(B̅).

4 Concealment Schemes

We propose methods for concealing arbitrary message multivectors with the support of a secret key. The secret key is a tuple consisting of two secret multivectors k=(K̅₁,K̅₂), where K̅₁,K̅₂∈ [symbol] ³, for which an inverse must exist. We denote the set of invertible secret key multivectors as K̅={K̅|∃K̅⁻¹∈ [symbol] ³}.

Definition 12. A Concealment Scheme is a polynomial-time algorithm that hides a message multivector by computing a concealed multivector with the support of secret key multivectors.

4.1 Clifford Sylvester's Equation Concealment (CSEC)

The first concealment scheme we propose is based on the well-known Sylvester's equation, where we make use of its multivector variant.

Definition 13. CSEC Forward Mapping (C̅=\vec{CSEC}(k,M̅)) Given a secret tuple k=(K̅₁,K̅₂), where K̅₁,K̅₂∈K, and a message multivector M̅∈ [symbol] ³, we can compute a concealed multivector C̅∈ [symbol] ³ such that C̅=\vec{CSEC}(k,M̅)=K̅₁M̅+M̅K̅₂.

Definition 14. CSEC Backward Mapping (M̅= [symbol] (k,C̅)) Given a secret tuple k=(K̅₁,K̅₂), for K̅₁,K̅₂∈ [symbol] ³, and a concealed multivector C̅∈ [symbol] ³, a message multivector M̅∈ [symbol] ³ is recovered by computing:

M̅= [symbol] (k,C̅)=(K̅₁+K̅₂+K̅₁⁻¹K̅₂K̅₂⁻¹+K̅₁)⁻¹(K̅₁⁻¹C̅K̅2+C̅) Eq. 6

Theorem 5. Correctness of CSEC For all k=(K̅₁,K̅₂) and for all M̅,C̅∈ [symbol] ³, the following holds: [symbol] (k,\vec{CSEC}(k,M̅))=M̅.

Proof. Given

C̅=K̅₁M̅+M̅K̅₂ Eq. 7

left multiply by K̅₁⁻¹ and right multiply by K̅₂ both sides of Eq. 7:

K̅₁⁻¹C̅K̅₂=K̅₁⁻¹K₁M̅K̅₂+K̅₁⁻¹M̅K̅₂K̅₂ Eq. 8

According to Definition 3, K̅₁⁻¹K̅₂=1, which allows us to simplify (8) as follows:

K̅₁⁻¹C̅K̅₂=M̅K̅₂+K̅₁⁻¹M̅K̅₂K̅₂ Eq. 9

If we sum Eq. 9 with Eq. 7 and combine like terms, we obtain the following:

K̅₁⁻¹C̅K̅₂=M̅(K̅₂+K̅₂)+K̅₁⁻¹M̅K̅₂K̅₂+K̅₁M̅ Eq. 10

Note that (K̅₂+K̅₂) and K̅₂K̅₂ are commuting complex-like numbers, which allows us to re-write Eq. 10 as follows:

K̅₁⁻¹C̅K̅₂=(K̅₂+K̅₂+K̅₁⁻¹K̅₂K̅₂+K₁)M̅ Eq. 11

We can now solve Eq. 11 for M to obtain:

M̅=(K̅₂+K̅₂+K̅₁⁻¹K̅₂K̅₂+K̅₁)⁻¹(K̅₁⁻¹C̅K̅₂+C̅). Eq. 12

Remark 5. The CSEC scheme is homomorphic with respect to addition, since adding C̅₁=K̅₁M̅₁+M̅₁K̅₂ to C̅₂=K̅₁M̅₂+M̅₂K̅₂ results in C̅₁+C̅₂=K̅₁(M̅₁+M̅₂)+(M̅₁+M̅₂)K̅₂. However, it is not homomorphic with respect to multiplication.

4.2 Modular Concealment (MC)

Definition 15. MC Forward Mapping (C̅=\vec{MC}(k,M̅)) Given a secret tuple k=(K̅₁,K̅₂), a message multivector M̅∈ [symbol] ³, and a random multivector R̅∈ [symbol] ³, we compute a concealed multivector C̅∈ [symbol] ³ such that C̅=\vec{MC}(k,M̅)=R̅K̅₁K̅₂+M̅.

Definition 16. MC Backward Mapping (M̅= [symbol] (k,C̅)) Given a secret tuple tuple k=(K̅₁,K̅₂), for K̅₁,K̅₂∈ [symbol] ³, and a concealed multivector C̅∈ [symbol] ³, a message multivector M̅∈ [symbol] ³ is recovered as M̅= [symbol] (k,C̅)=C̅ mod(K̅₁K̅₂).

Theorem 6. Correctness of MC For all k∈K and for all M̅∈ [symbol] ³, the following holds:: [symbol] (k,\vec{MC}(k,M̅))=M̅.

Proof. The modulo operation Ā mod B̅ is computed in terms of the multivector packing that generated the message multivector such that M̅₁ mod M̅₂≡m₁ mod m₂. Let R̅, K̅₁, K̅₂, and M̅ be the multivector representation of the integers r, k₁, k₂, and m, respectively, therefore, (R̅K̅₁K̅2+M̅)mod(K̅₁K̅₂), which is equivalent to (rk₁k₂+m) mod(k₁k₂)=m.

Remark 6. The MC is both additive and multiplicative homomorphic for all message multivectors M̅<(K̅₁,K̅₂), which is equivalent of saying that, given C̅₁=\vec{MC}(k,M̅₁) and C̅₂=\vec{MC}(k,M̅₂), then [symbol] (C̅₁∘C̅₂)=(C̅₁∘C̅₂)mod(K̅₁K̅₂), which is equivalent to (m₁∘m₂)mod(k₁k₂) for ∘∈{+,·}.

In the disclosure described thus far, it has been demonstrated how multivector involutions, decompositions, and a small set of multivector functions can be combined and explored as the sufficient components to implement protocol-agnostic homomorphic data representation and homomorphic data concealment with Clifford geometric algebra. Two methods for representing numerical data were introduced, namely multivector packing schemes, such that a given datum is expressed in terms of the output of the Clifford eigenvalue and the rationalize functions. Also introduced were two methods for hiding data represented as multivectors, namely concealment schemes, which consist of operations that compute a concealed multivector with the support of secret key multivectors. The multivector packing and concealment schemes discussed in this disclosure are homomorphic with respect to addition, multiplication or both. These constructions may be used in a wide variety of privacy preserving applications since, due to its homomorphic properties, data can be meaningfully computed while concealed. The homomorphism on both packing and concealment schemes provides a guarantee that applying methods of the various embodiments will not compromise the numerical meaning of the data represented and concealed as multivectors.

5 Additional Experiments with Clifford GA Applied to Cryptography

The combination of flexibility, simplicity, elegance and power that is found in Clifford Geometric Algebra (GA) is probably one of the main reasons for a growing interest from those willing to explore new algebraic structures for producing many applications in physics, engineering and computer science. As a result, to the surprise of many, existing applications when modified to run as implementations of Clifford GA algorithms, demonstrate higher performance, better maintenance, less complexity and friendlier learning curve for those new to GA. Nonetheless, Clifford GA is virtually unexplored in cryptography, an area of science that can be greatly benefited by a mathematical tool equipped with the aforementioned potential. In the additional disclosure below, experiments of cryptographic solutions based on Clifford geometric algebra are introduced, including a key exchange protocol, a hash algorithm and a private-key encryption scheme.

Modem cryptography (post-1980s) distinguishes from its classical counterpart by its emphasis on definitions, precise assumptions and rigorous proofs. A slightly different description of modern cryptography, says modern cryptography's emphasis is on definitions, schemes and proofs. In both descriptions, definitions are the very step in designing a cryptographic solution. Modem cryptography relies on formally stating what security means for a particular cryptographic mechanism. Definitions of security can sometimes be very strong, however, while efficient constructions that satisfy such strong definitions exist, some cryptographic constructions cannot be unconditionally proven secure. For this reason, most security definitions rely on clearly stated and unambiguously defined (yet unproven) assumptions. Once security definitions and precise assumptions are in place, one particular construction can be proven secure with respect to some clearly stated security definition and under some well-defined cryptographic assumption(s). Once security definitions are stated, one needs to design schemes in the hope that they meet some particular security definition. In combining both descriptions, we have four fundamental building blocks of modem cryptography: definitions, assumptions, schemes and proofs.

One can see these building blocks as what is needed to be achieved. When it comes to how achieve the goals, this really should be a decision of the cryptographic designer. From the 1980s to the present time, a tremendous advance in cryptology as a whole is being witnessed, expressed in new notions of security, new threat models, new attacks, new primitives, new protocols, new goals, etc. At the same time, however, many of these contributions rely on a small set of mathematical resources such as modular arithmetic, group theory, combinatorics, probability, integer factorization, discrete logarithm, elliptic curves, lattices, coding theory, linear algebra, among others. Once the previously discussed building blocks of modern cryptography are in place, i.e., a cryptographer knows what the end goal is, one should not be limited to the aforementioned mathematical tools in order to provide the how. Many other branches of mathematics, sometimes virtually unexplored in cryptography, have interesting and promising properties, along with functionalities, that seem to be, at the very least, worth investigating. One appealing candidate for the task is Clifford Geometric Algebra (GA). With several applications, mostly in physics and engineering, there is a growing interest on the computational aspects of Clifford GA. Among CA's benefits, a highlight is the unification of many mathematical systems into an easy-to-understand mathematical framework, which can serve as an extension of standard programming languages while enabling compact algorithms that can run in parallel yielding high runtime performance and robustness.

5.1 Auxiliary Algorithms

Before proposing GA-based methods for several applications in cryptography we want to define some auxiliary algorithms that will be used in the next sections.

Definition 17: NumToMult_{mod} is a variation of NumToMult that transforms a number n∈ [symbol] into a multivector M̅∈ [symbol] ³ while defining that computation of the coefficients of M̅ will be reduced modulus q for q∈ [symbol] , q>1. We define the syntax as M̅=NumToMult_{mod} (n, b, q).

Definition 18: StrToMult_{mod} is a variation of StrToMult that transforms a string s into a multivector M̅∈ [symbol] ³ while defining that the computation of the coefficients of M̅ will be reduced modulus q for q a positive integer. We define the syntax as =̅StrToMult_{mod} (s, b, q).

Definition 19: RandMult_{mod} is a variation of RandMult that generates a multivector R̅∈ [symbol] ³ with random b-bits coefficients while defining that the computation of each coefficient will be reduced modulus q for q a positive integer. We define the syntax as R̅=RandMult_{mod} (b, q).

Lemma 1: A multivector M̅∈ [symbol] ³ is non-invertible if M̅M̅=0.

Proof: If M̅M̅=0, then R(M̅)=0, which results in a division by zero, therefore, M̅⁻¹ is undefined.

Definition 20: RandMultNI_{mod} is a variation of RandMult_{mod} that generates a non-invertible multivector M̅∈ [symbol] ³ with random b-bits coefficients while defining that the computation of each coefficient will be reduced modulus q. This is done by generating a random multivector M̅₁=RandMult_{mod} (b, q), uniformly generating a random n∈{0, . . . , 2^{b}−1) and creating a multivector M̅₂ where all of its coefficients are equal to r and then compute M̅=M̅₁M̅₂. We define the syntax as M̅=RandMultNI_{mod} (b, q).

Algorithm 1: Number to Multivector

Given n, b∈ [symbol] , we sorm n into M̅∈ [symbol] ³ as follows:

M̅=|n|₂_{^{b}}ē₀+Σ|└n/2^{ib}┘|₂_{^{b}}ēⱼ Eq. 13

for i=1 . . . 7 and j∈(1, 2, 3, 12, 13, 23, 123).

### Return M̅.

We define the syntax as M̅=NumToMult (n, b).

Algorithm 2: Multivector to Number

Given a multivector M̅∈ [symbol] ³ and a positive integer b, convert M̅ to n∈ [symbol] as follows: assign each coefficient of M̅ to nᵢ, i=1 . . . 8 such that:

n₁=m₁₂₃,n₂=m₂₃,n₃=m₁₃,n₄=m₁₂,n₅=m₃,n₆=m₂,n₇=m₁,n₁=m₀ Eq. 14

so the number n is computed as:

n=n₁,n=n·2^{b}+nᵢ,i=2 . . . 8 Eq.15

### Return n.

We define the syntax as n=MultToNum (M̅, b).

Algorithm 3: String to Multivector

Given a string s of size k, and a positive integer b, obtain the integer representation of each character of s in the form of:

S=(s₁ . . . sₖ),sᵢ∈{0, . . . ,255} Eq. 16

We compute a number n from S as follows:

n=s₁,n=n·256+sᵢ,i=2 . . . k Eq.17

We transform n in to the multivector M̅∈ [symbol] ³:

M=NumToMult(n,b) Eq. 18

### Return M.

We define the syntax as M̅=StrToMult (s, b).

Algorithm 4: Random Multivector

Given b, a positive integer, we generate the random coefficients r₀, r₁, r₂, r₃, r₁₂, r₁₃, r₂₃, r₁₂₃ uniformly select from the set {0, . . . , 2^{b}−1} such that:

R̅=r₀ē₀+r₁ē₁+r₂e₂+r₃ē₃+r₁₂ē₁₂+r₁₃ē₁₃+r₂₃ē₂₃+r₁₂₃ē₁₂₃ Eq. 19

### Return R̅.

We define the syntax as R=RandMult (b).

5.2. Key Exchange

When two parties want to establish a secret communication, they might resort to a cryptographic protocol known as Key Exchange or Key Agreement. We introduce a family of algorithms for a GA-based Key Exchange protocol denoted by Exch, which are efficient algorithms (i.e., probabilistic polynomial-time) designed for a peer-to-peer setting where each shared secret key is used only once per communication event. We define the syntax as:

Exch=(Init_{party},PCI_{party},Subkey_{party},Exch_{party}). Eq. 20

For any two parties, Party 1 and Party 2, the following algorithms apply. Each party has a public ID, denoted by P̅ᵤ, and a private ID, denoted by P̅ᵣ.

In order to initiate a key exchange, we need to initialize both parties, as shown in Algorithm 5, and have them agreeing on a public communication identifier G that is generated according to Algorithm 6. Each party will compute their subkey, as defined in Algorithm 7, which will be exchanged so both parties can compute the same secret key locally, according to Algorithm 8.

Definition 21: We consider the probability of an event x to occur to be negligible if all elements of a sufficiently large space solution S have approximately equal probability to occur. We define the syntax as Pr[x]≈1/S.

Definition 22: For all non-invertible public communication identifier G̅ and secret ID P̅ᵣ_{ᵢ}, such that S̅₁=P̅ᵣ_{₁}G̅ and S̅₂=G̅P̅ᵣ_{₂}, the Key Exchange protocol Exch is secure if the probability of an adversary algorithm [symbol] solving for P̅ᵣ_{ᵢ} from S̅ᵢ is negligible. We write:

Pr└ [symbol] (S̅ᵢ)=P̅ᵢ┘≈1/| [symbol] |,:i=1,2 Eq. 21

where [symbol] is the space of all possible final K̅ such that K̅∈ [symbol] .

Assumption 1: Solving a unique sample of an underdetermined non-linear system of equation, that is, a non-linear system with fewer non-redundant possible equations than unknowns to solve, for any sufficiently large space solution, where the attacker has only one sample of data for every set of unknowns to solve, is hard.

As part of the share secret agreement, the parties agree on the index i each one will use. There's no secrecy for this particular assignment. If the index i is incorrectly assigned, the secret keys computed by both parties will not match.

Algorithm 5: Party Initialization

Remark 7: The public identifier P̅ᵤ_{ᵢ} is generated by algorithm RandMultNI_{mod} as a non-invertible multivector. This means that G̅ is also non-invertible since G̅=P̅ᵤ_{₁}P̅ᵤ_{₂}. This is relevant since the computation of the subkey S̅ᵢ is a product of G̅ and the private ID P̅ᵣ_{ᵢ}. If G̅ was invertible, recovering the private key of the parties would be trivial. Since G̅ is non-invertible, the product with S̅ᵢ is also a non-invertible. Given that every instance of proposed key exchange protocol is used only once, solving for P̅ᵣ_{ᵢ} from S̅ᵢ requires solving for an underdetermined non-linear system of equations.

Algorithm 6 considers that two parties that intend to share a secret key were already initiated. The first party is assigned with i=1 and the second party with i=2. Party 1 generated (P̅ᵣ_{₁}, P̅ᵤ_{₁})=Partyₗᵢₙₖ (λ, 1) and party 2 generated (P̅ᵣ_{₂}, P̅ᵤ_{₂})=Partyₗᵢₙₖ (λ, 2), for a particular agreed value of λ, where P̅ᵣ_{₁} and P̅ᵣ_{₂} are kept private at all times and P̅ᵤ_{₁} and P̅ᵤ_{₂} are made public.

Algorithm 6: Public Communication Identifier

Given two public party identifiers P̅ᵤ_{₁} and P̅ᵣ_{₂}, generate the public communication identifier as G̅=P̅ᵤ_{₁}P̅ᵤ_{₂}.

### Return G̅.

We define the syntax as G̅=PCI_{party} (P̅ᵤ_{₁}P̅ᵤ_{₂}).

Since P̅ᵤ_{₁} and P̅ᵤ_{₂} are public, C can also be locally computed. Once G̅ is computed, each party computes their subkey. Algorithm 7 defines how each subkey must be computed depending on the i assigned to each party.

Algorithm 7: SubKey

Given the party private ID P̅ᵣ_{ᵢ}, the public communication identifier G̅, and the index i, generate the subkey S̅ᵢ such that:

If i=1 then S̅₁=P̅ᵣ_{₁}G̅. If i=2 then S̅₂=G̅P̅ᵣ_{₂}.

### Return S̅ᵢ.

We define the syntax as S̅ᵢ=Subkey_{party} (P̅ᵣ_{ᵢ},G̅,i).

Algorithm 8: Exchange

Give party 1 subkey S̅₁, party 2 subkey S̅₂, the public communication identifier G̅, and the index i, generate the shared secret key K̅_{idcalc} (i.e., K̅_{shared}) such that:

if i=1 then K̅_{1dcalc}=P̅ᵣ_{₁}S̅₂G̅+G̅+1. If i=2 then K̅_{2dcalc}=S̅₁P̅ᵣ_{₂}G̅+G̅+1.

### Return K̅ᵢ.

We write K̅_{idcalc}=Exch_{party} (S̅ᵢ,P̅ᵣ_{ᵢ},G̅,i).

Party 1 computes S̅₁ and sends it to party 2. Party 2 computes S̅₂ and sends it to party 1. This is the only exchange of information between the parties, besides the original public information. Finally, both parties locally compute the secret key, each one according to their assigned i, according to Algorithm 8.

Theorem 7: For all P̅ᵣ_{₁}, P̅ᵤ_{₁}, P̅ᵣ_{₂}, P̅ᵤ_{₂}, generated by Init_{party}, all G̅ generated by PCI_{party}, all S̅₁,S̅₂ generated by Subkey_{party}, and all K_{1dcalc}, K_{2dcalc} generated by Exch_{party}, it holds that K̅_{1dcalc}=K̅_{2dcalc}=K̅_{shared}.

Proof: Let K̅_{1dcalc} be the secret key computed by party 1 and K̅_{2dcalc} be the secret key computed by party 2. Party 1 computes K̅_{1dcalc} as follows:

$$\begin{matrix}{\overline{K}}_{1 dcalc} = {Exch}_{party} ( {\overline{S}}_{2} , {\overline{P}}_{{r}_{1}} , \overline{G} , 1 ) \\ = {\overline{P}}_{{r}_{1}} {\overline{S}}_{2} \overline{G} + \overline{G} + 1 \\ = {\overline{P}}_{{r}_{1}} \overline{G } {\overline{P}}_{{r}_{2}} \overline{G} + \overline{G} + 1 \\ = {\overline{P}}_{{r}_{1}} {\overline{P}}_{{u}_{1}} {\overline{P}}_{{u}_{2}} {\overline{P}}_{{r}_{2}} {\overline{P}}_{{u}_{1}} {\overline{P}}_{{u}_{2}} + ( {\overline{P}}_{{u}_{1}} {\overline{P}}_{{u}_{2}} ) + 1\end{matrix} \qquad Eq . 23$$

Party 2 computes K̅_{2dcalc} as follows:

$$\begin{matrix}{\overline{K}}_{2 dcalc} = {Exch}_{party} ( {\overline{S}}_{1} , {\overline{P}}_{{r}_{2}} , \overline{G} , 2 ) \\ = {\overline{S}}_{1} {\overline{P}}_{{r}_{2}} \overline{G} + \overline{G} + 1 \\ = {\overline{P}}_{{r}_{1}} \overline{G } {\overline{P}}_{{r}_{2}} \overline{G} + \overline{G} + 1 \\ = {\overline{P}}_{{r}_{1}} {\overline{P}}_{{u}_{1}} {\overline{P}}_{{u}_{2}} {\overline{P}}_{{r}_{2}} {\overline{P}}_{{u}_{1}} {\overline{P}}_{{u}_{2}} + ( {\overline{P}}_{{u}_{1}} {\overline{P}}_{{u}_{2}} ) + 1\end{matrix} \qquad Eq . 24$$

and we verify that K̅_{1dcalc}=K̅_{2dcalc}=K̅_{shared}.

5.2.1. Key Exchange Protocol

Given that Alice (Party 1) and Bob (Party 2) agreed upon a value for λ, the key exchange routine proceeds as follows:
1) Alice generates her identification:

(P̅ᵣ_{₁},P̅ᵤ_{₁})=Init_{party}(λ,1) Eq. 25

2) Bob generates his identification:

(P̅ᵣ_{₂},P̅ᵤ_{₂})=Init_{party}(λ,2) Eq. 26

3) Alice and Bob establish a public communication identifier:

G̅=PCI_{party}(P̅ᵤ_{₁},P̅ᵤ_{₂}) Eq. 27

4) Alice generates and sends to Bob her subkey:

S̅₁=Subkey_{party}(P̅ᵣ_{₁},G̅,1) Eq.28

5) Bob generates and sends to Alice his subkey:

S̅₂=Subkey_{party}(P̅ᵣ_{₂},G̅,2) Eq. 29

6) Alice privately calculates the shared secret key:

K̅_{1dcalc}=Exch_{party}(S̅₂,P̅ᵣ_{₁},G̅,1) Eq. 30

7) Bob privately calculates the shared secret key:

K̅_{2dcalc}=Exch_{party}(S̅₁,P̅ᵣ_{₂},G̅,2) Eq. 31

8) Alice and Bob now share the same secret key. (K̅_{1dcalc}=K̅_{2dcalc}=K̅_{shared}

Theorem 8: The GA-based Key Exchange protocol Exch is secure under Assumption 1.

Proof: Given a multivector Ā that is unknown and a non-invertible multivector B̅ that is known, such that B̅=bē₀+bē₁+bē₂+bē₃+bē₁₂+bē₁₃+bē₂₃+bē₁₂₃, the geometric product C̅=ĀB̅ is given by:

c₀=c₃=(a₀b+a₁b+a₂b+a₃b−a₁₂b−a₁₃b−a₂₃b−a₁₂₃b)

c₁=c₁₃=(a₀b+a₁b−a₂b−a₃b+a₁₂b+a₁₃b−a₂₃b−a₁₂₃b)

c₂=c₂₃=(a₀b+a₁b+a₂b+a₃b−a₁₂b+a₁₃b+a₂₃b+a₁₂₃b)

c₁₂=c₁₂₃=(a₀b+a₁b−a₂b+a₃b+a₁₂b−a₁₃b+a₂₃b+a₁₂₃b) Eq.32

Thus, the geometric product involving at least one non-invertible multivector generates a multivector that is expressed by four non-redundant equations as opposed to eight, which is the case when the geometric product results on an invertible multivector. Any multivector multiplied by C̅ will carry the equalities in Eq. 32. Recall that in Algorithm 5 the multivector P̅ᵣ_{ᵢ} is generated with eight distinct coefficients, thus requiring eight distinct equations to be recovered. Since all P̅ᵣ_{ᵢ}, P̅ᵤ_{ᵢ}, G̅ and S̅ᵢ are all unique per communication, it is guaranteed that the system of equations for solving for P̅ᵣ_{ᵢ} is always underdetermined. This is true assuming that the attack here is any attempt (by any means) of solving an underdetermined system of equations with a single sample. The attacker does not have the ability to collect samples under the same key since the protocol is meant to be used only once per key.

A multivector in G̅³ written M̅=s+ν+jw+jt fails to have an inverse if s²+w²=ν²+t², Z̅²=F̅², where Z̅=+ and Z̅= [symbol] M̅ [symbol] ₀+ [symbol] M̅ [symbol] ₃ and Z̅= [symbol] M̅ [symbol] ₁+ [symbol] M̅ [symbol] ₂. We follow Theorem 8 to state this formally.

Theorem 9: For all M̅∈ [symbol] ³ defined according to Theorem 8, such that:

M=aē₀+bē₁+cē₂+aē₃+dē₁₂+aē₁₃+bē₂₃+dē₁₂₃ Eq. 33

the following holds:

s²+w²=ν²+t²,Z̅²=F̅² Eq. 34

where M̅=s+ν+jw+jt.

Proof: For M̅∈ [symbol] ³ defined as in Theorem 9, let s=a, ν=bē₁+cē₂+aē₃, w=dē₁₂+aē₃+bē₂₃, t=d, v²=b²+c²+a², w²=d²+b²+c². We verify that:

s²+w²=a²+b²+c²+d²

v²+t²=a²+b²+c²+d²

Z̅²=a²−d²ē₀+2adē₂₃

F̅²=a²−d²ē₀+2adē₁₂₃ Eq.35

thus s²+w²=v²+t² and Z̅²=F̅².

5.3. Edge Computing

One could wonder how useful and/or realistic is a key exchange protocol that generates secret keys that are meant to be used only once. In order to provide an answer with insights for real-world applications, we discuss a scenario where a device requests access to a server. Prior to granting access, the server and the device must agree upon a secret key that must be generated and used only once. This can be seen as a device handshake technique for establishing communications between devices in an Edge Computing setting. To solve this problem, we propose a protocol for edge computing that is based on the key exchange protocol discussed in Section III.

The security definition of this protocol is given by Definition 22 under Assumption 1.

Definition 23: The Edge Computing protocol is composed by the family of algorithms ES (Edge Server) and ED (Edge Device).

Definition 24: The Edge Server family of algorithms is denoted by:

ES=(Initₛₑᵣᵥₑᵣ,InitReqₛₑᵣᵥₑᵣ,Regₛₑᵣᵥₑᵣ,ReqDataₛₑᵣᵥₑᵣ). Eq. 36

Such that:

1) Initₛₑᵣᵥₑᵣ initializes a server instance;

2) InitReqₛₑᵣᵥₑᵣ processes a device's access authorization request;

3) Regₛₑᵣᵥₑᵣ authorizes a device to access the server instance;

4) ReqDataₛₑᵣᵥₑᵣ processes a device's data access request.

Definition 25: The Edge Device family of algorithms is denoted by:

ED=(Init_{device},Exch_{device},Rec_{device}). Eq. 37

Such that:

1) Init_{device} initializes a device instance;

2) Exch_{device} processes the server's authorization response;

3) Rec_{device} processes the data received by the server.

Algorithm 9: Edge Server Initialization

The Edge Server initialization receives X as argument and computes b=λ/8 and q such that q is the next prime greater than b. It initializes also an empty list A and a data list B with some data in it. The initialization returns an object s=(b, q, A, B).

### Return s.

We define the syntax as s=Initₛₑᵣᵥₑᵣ (λ).

Algorithm 10: Server Initiate Request

The Edge Server initialization request receives a device's public ID P̅ᵤ_{₂} as argument and proceeds as follows:

Create the server's private and the public identifier (P̅ᵣ_{₁},P̅ᵤ_{₁}) such that (P̅ᵣ_{₁},P̅ᵤ_{₁})=Init_{Party} (λ, 1).
Compute the public communication identifier G̅=P̅ᵤ_{₁}P̅ᵤ_{₂}.
Compute the subkey S̅₁=Subkey_{party}(P̅ᵣ_{₁},C̅,1).
Add P̅ᵣ_{₁}, P̅ᵤ_{₁}, S̅₁ to s such that: s=(b,q,A,B,P̅ᵣ_{₁},P̅ᵤ_{₁},S₁).

### Return s.

We define the syntax as s=InitReqₛₑᵣᵥₑᵣ (P̅ᵤ_{₂}).

Algorithm 11: EDGE Server Registration

The Edge Server registration receives a device's public ID P̅ᵤ_{₂} as argument and proceeds as follows:

Computes the shared secret key K̅_{1dcalc}=Exch_{party} (S̅₂,P̅ᵣ_{₁},G̅,1) and the flag false to A such that A=(P̅ᵤ_{₂},K̅_{1dcalc},false).
Add K̅₁ to s such that s=(A,B,P̅ᵣ_{₁},P̅ᵤ_{₂}, S̅₂,K̅_{1dcalc}).

### Return s.

We define the syntax as s=Regₛₑᵣᵥₑᵣ (P̅ᵤ_{₂},S̅₂).

Algorithm 12: Edge Server Request Data Process

The Edge Server request data process receives a device's public ID P̅ᵤ_{₂} and a data ID j as arguments and proceeds as follows:

Search and select in the A list a tuple with the device's public ID that matches P̅ᵤ_{₂} and that has a flag false. If no entry is found, return 0. If an entry is found, select the data D̅ as the j-th element of B. With the K̅_{1dcalc} stored in A for P̅ᵤ_{₂}, compute C̅ as follows:

C̅=K̅_{1dcalc}D̅K̅_{1dcalc}^{†} Eq. 38

### Return C̅.

We define the syntax C̅=ReqDataₛₑᵣᵥₑᵣ (P̅ᵤ_{₂},j).

Algorithm 13: Edge Device Initialization

Given λ, compute b−λ/8 and q such that q is the first prime greater than b. Create the devices' private and the public identifier (P̅ᵣ_{₂},P̅ᵤ_{₂}) such that b=(P̅ᵣ_{₂},P̅ᵤ_{₂})=Init_{party} (λ, 2).

We define the syntax as [symbol] =Init_{device} (λ).

Algorithm 14: Edge Device Exchange

The Edge Device exchange receives a server's public ID P̅ᵤ_{₁} and subkey S̅₁ and proceeds as follows:

Compute the public communication identifier G̅=P̅ᵤ_{₁}P̅ᵤ_{₂}. Compute the device's subkey S̅₂=Subkey_{party} (P̅ᵣ_{₂},G̅,2). Compute the shared secret key K_{2dcalc}=Exch_{party} (S̅₁,P̅ᵣ_{₂},G̅,2).
Return [symbol] =(P̅ᵣ_{₂},P̅ᵤ_{₂},G̅,S̅₂,K̅_{2dcalc}).
We define the syntax as [symbol] =Exch_{device} (P̅ᵤ_{₁},S̅₁)

Algorithm 15: Edge Device Receive Data Process

The Edge Device receive data process receives C as argument and proceeds as follows:

Compute D̅=K̅_{2dcalc}⁻¹(K_{2dcalc}^{†})⁻¹.

### Return D.

We define the syntax as D̅=Rec_{device} (C̅).

5.3.1. Edge Computing Protocol

The Edge Computing protocol is described next:
1) A server is initiated: s=Initₛₑᵣᵥₑᵣ (λ)
2) A device is initiated: [symbol] =Init_{device} (λ)
3) A device sends P̅ᵤ_{₂} to the server, which initiates the device's request by computing G̅ and the subkey S̅₁: s=InitReqₛₑᵣᵥₑᵣ (P̅ᵤ_{₂}). The server sends S̅₁ to the device.
4) By receiving the subkey from the server, the device computes its subkey and shared secret key: [symbol] =Exch_{device} (P̅ᵤ_{₁},S̅₁). The device sends S̅₂ to the server.
5) By receiving the subkey S̅₂ from the device, the server registers and authorizes the device: s=Regₛₑᵣᵥₑᵣ (P̅ᵤ_{₂},S̅₂).
6) The device sends its public ID P̅ᵤ_{₂} and a datum ID j to the server which process and encrypts the request: C̅=ReqDataₛₑᵣᵥₑᵣ (P̅ᵤ_{₂},j). The server sends C̅ to the device.
7) The device processes C̅ in order to obtain D̅: D̅=Rec_{device} (C̅).

5.4 Hash Algorithm

A secure Hash algorithm is meant to be a one-way function, that is, a function that is easy to compute and to verify but infeasible to invert. With elementary functions in GA, the use of rounds and coefficients reduced to a certain modulus we propose a lightweight, simple and yet promising GA-based Hash algorithm. Let the bit size of the message digest generated by the Hash algorithm be denoted by λ. We define an iterative Hash algorithm consisting of one-way hash functions that are able to process a message and result in a condensed representation called message digest. The proposed GA Hash algorithm can be used for a variety of applications, including, determining a message's integrity and it is denoted as h=GAHash_{dige} (λ) where GAHash (Algorithm 18) is the combination of the algorithms GAHashₚᵣₑₚ (Algorithm 16) and GAHa_{sche} (Algorithm 17).

Algorithm 16: Prepossessing

Given λ, a string s, b=λ/8, q=2^{b}, we transform it into a multivector M̅ as M̅=StrToMult (s, b) and we reduce each coefficient of M̅ to the modulus and all the GA computation will be performed reduced to modulus q.

We compute a value multivector V̅ where each coefficient of V̅ is the first b bits of the fractional part of the square root of the first eight prime numbers.

### Return (V̅,M̅).

We define the syntax as (V̅,M̅)=GAHashₚᵣₑₚ (λ, s).

Algorithm 17: Message Schedule

Given a number r of rounds, successively update V̅ and M̅ as follows:

V̅=V̅^{†}+V̅V̅V̅+V̅^{†}

M̅=V^{†}−M̅M̅M̅−M̅ Eq. 39

We let h be the concatenation of coefficients of M̅ converted to hexadecimal.

### Return h.

We define the syntax as h=GAHash_{sche} (V̅,M̅).

Algorithm 18: GA Hash

Given λ, and a string s, compute V̅ and M̅ such that (V̅,M̅)=GAHashₚᵣₑₚ (λ) then compute the hash value h=GAHash_{sche} (V̅,M̅).

### Return h.

We define the syntax as h=GAHash_{dige} (λ, s)

Remark 8: For every string s a hash value h is computed such that h=GAHash_{dige} (λ, s). In Algorithm 17, the computation of the hash value is based on a message schedule mechanism defined in Eq. 39. Given a number r of rounds, the value multivector V̅ and the message multivector M̅ are updated r times where M̅ is dependent on V̅ in each iteration where the arithmetic of coefficients of V̅ and M̅ is reduced modulo q. Since one does not know what the original value of M̅ is, we assume that, even though GAHash_{dige} is efficiently computed, inverting it is infeasible, which under this assumption it is qualified as a one-way function.

Remark 9: A hash function, to be considered secure, is expected to be collision resistant (finding two different inputs that have the same hash value), preimage resistant (or have the one-way property, that is, given a randomly chosen h it must be infeasible to find s such that h=GAHash_{dige} (λ, s) for any fixed X and second preimage resistant (given s and its corresponding h, finding a second input s′ which its corresponding h′ satisfies h=h′. An evident follow-up of this experiment is investigating if these properties are present in our proposed hash function.

5.5. An Encryption Experiment

We now propose a combination of many of the ideas discussed in the previous sections in order to introduce a probabilistic private-key encryption scheme. In order to provide a concrete insight about the security of the proposed encryption scheme we will introduce some strong assumptions while we will attempt to avoid those to be too strong. We will then claim security based on those assumptions.

In order to provide a probabilistic encryption (encrypting the same input multiple times will randomly generate different ciphertexts) we will use a variation of the RandMult_{mod} algorithm, as stated in Definition 26.

Definition 26: NumToRandMult_{mod} is a variation of RandMult_{mod} that generates a random multivector M̅ where m₀, m₁, m₂, m₁₂, m₁₃, m₂₃, m₁₂₃ are coefficients uniformly selected from {0, . . . , 2^{b}−1} and m₃ is defined to be the number passed as input, such that m₃=n. We define the syntax as M̅=NumToRandMult_{mod} (n, b, q).

Definition 27: For the proposed private-key scheme, we consider three spaces: the key space [symbol] , containing all possible secret keys, the message space [symbol] , containing all possible messages, and the ciphertext space [symbol] , containing all possible ciphertexts.

Definition 28: The private-key encryption scheme Π is composed by three polynomial-time algorithms that we denote by Π=(Gen, Enc, Dec) such that:
1) Gen is a probabilistic polynomial-time algorithm that takes the security parameter λ as input and output a uniformly generated secret key invertible multivector K̅∈ [symbol] such that b=λ/8 and q is the first prime greater than 2^{b}, where b and q are public. We define the syntax as (K̅,b,q)←Gen(λ).
2) Enc is a probabilistic polynomial-time algorithm that takes a secret key K̅∈ [symbol] and a message M̅∈ [symbol] as input and output a ciphertext C̅∈ [symbol] . We start by setting C̅₀=M̅, where M̅=NumToRandMult_{mod} (m, b, q) and K̅₀=K̅. Then, for i=1 . . . r, where r is a fixed value that determines how many rounds will be executed, C̅ᵢ is computed as follows:

K̅ᵢ=K̅ᵢ₋₁^{†}+K̅ᵢ₋₁K̅ᵢ₋₁K̅ᵢ₋₁+K̅ᵢ₋₁^{†}

C̅ᵢ=K̅ᵢ₋₁^{†}K̅ᵢ₋₁C̅ᵢ₋₁K̅ᵢ₋₁K̅ᵢ₋₁^{†}
At the end of the r-th iteration, we set C̅=C̅ᵣ. We write C̅←Enc (K̅, m).
3) Dec is a deterministic polynomial-time algorithm that takes a secret key K̅∈ [symbol] and a ciphertext C̅∈ [symbol] as input and output the message M̅∈ [symbol] as follows: we set K̅₀=K̅ and C̅ᵣ=C̅. Then, for i=1 . . . r, we compute all K̅ᵢ:

K̅ᵢ=K̅ᵢ₋₁^{†}+K̅ᵢ₋₁K̅ᵢ₋₁K̅ᵢ₋₁+K̅ᵢ₋₁^{†} Eq. 41
Then, for i=r . . . 1, we compute all C̅ᵢ as follows:

C̅ᵢ₋₁=K̅ᵢ⁻¹((K̅ᵢ^{†})⁻¹C̅ᵢ(K̅ᵢ^{†})⁻¹)K̅ᵢ⁻¹ Eq. 42
At the end of the r-th round we set M̅=C̅₀ and m=m₃. We define the syntax as m=Dec (k, C̅),

Definition 29: The proposed encryption scheme is secure if the probability of an adversary algorithm A solving for K̅ or m from C̅ is negligible. We write:

$$Pr [ A ( \overline{C} ) = X ] \approx \frac{1}{\vert K \vert} , X = \overline{K} , m . \qquad Eq . 43$$

Assumption 2: C̅=Enc (K̅,m) is a one-way function and as such it is infeasible to invert in the average case.

Proof: For this experiment, we provide a tautological proof of security, that is, if Enc is indeed a one-way function, then the encryption scheme Π is secure given that inverting one-way functions is considered to be hard.

Remark 10: The encryption algorithm is inspired in the message schedule GAHash_{sche} and hence is here assumed to be a one-way function.

Remark 11: The encryption scheme Π can work with the secret key generated by Gen, as defined in Definition 28, or might consider an agreed secret key generated by the key exchange protocol Exch.

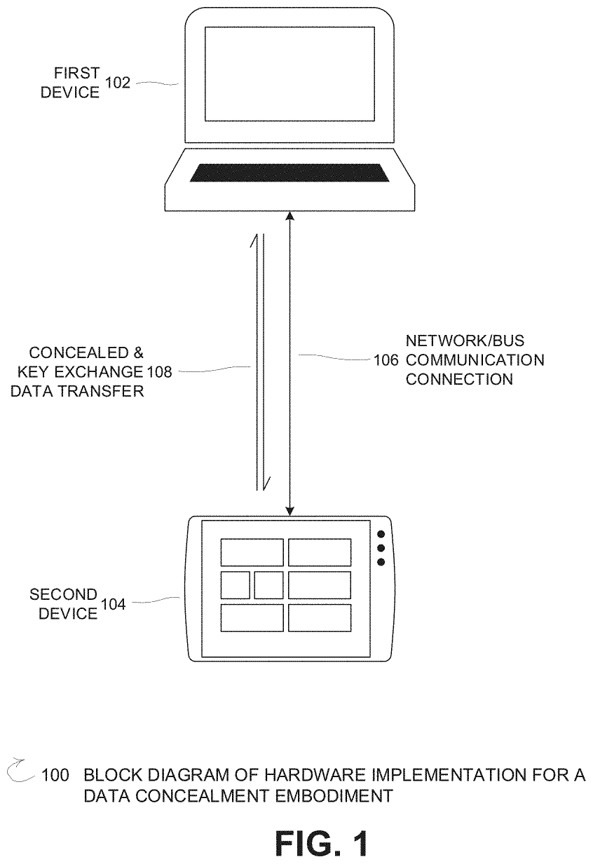

### Hardware Implementation for Data Concealment Embodiments (FIG. 1)

FIG. 1 is a block diagram 100 of the hardware implementation for a data concealment embodiment. A first device 102 is connected over an electronic network/bus connection 106 to a second device 104. In the embodiment shown in FIG. 1, the first device 102 acts as the source of the concealed message and the first device 102 sends the concealed data 108 over the network/bus connection 106 to the second device 104. The second device 104 acts as a destination for the concealed data received 108 from the network/bus connection 106. Generally, communications, including concealed/encrypted communications, are bi-directional such that the first 102 and second 104 devices may change roles as the concealed data 108 source and the concealed data 108 destination as is necessary to accommodate the transfer of data back and forth between the computing devices 102, 104. Additionally, while the computing devices 102, 104 are depicted as separate devices in FIG. 1, the functionality of the first device 102 and the second device 104 may be shared on a single computing system/device or among two computing devices as it is often desirable to conceal data when transferring data between components of a single device.

Further, as shown in FIG. 1, the first device 102 appears to be a laptop computer and the second device 104 appears to be a tablet device. Generally, any computing device capable of communication over any form of electronic network or bus communication platform 106 may be one or both of the first 102 and second 104 computing devices. Additionally, the first 102 and second 104 computing devices may actually be the same physical computing device communicating over an internal bus connection 106 with itself, but still desiring to conceal transferred data to ensure that an attacker cannot monitor the internal communications bus 106 to obtain sensitive data communications in an unconcealed format.

Various embodiments may implement the network/bus communications channel 106 using any communications channel 106 capable of transferring electronic data between the first 102 and second 104 computing devices. For instance, the network/bus communication connection 106 may be an Internet connection routed over one or more different communications channels during transmission between the first 102 and second 104 devices. Likewise, the network/bus communication connection 106 may be an internal communications bus of a computing device, or even the internal bus of a processing or memory storage Integrated Circuit (IC) chip, such as a memory chip or a Central Processing Unit (CPU) chip. The network/bus communication channel 106 may utilize any medium capable of transmitting electronic data communications, including, but not limited to: wired communications, wireless electro-magnetic communications, fiber-optic cable communications, light/laser communications, sonic/sound communications, etc., and any combination thereof of the various communication channels.

The various embodiments may provide the control and management functions detailed herein via an application operating on the first 102 and/or second 104 computing devices. The first 102 and/or second 104 computing devices may each be a computer or computer system, or any other electronic devices device capable of performing the communications and computations of an embodiment. The first 102 and/or second 104 devices may include, but am not limited to: a general purpose computer, a laptop/portable computer, a tablet device, a smart phone, an industrial control computer, a data storage system controller, a CPU, a Graphical Processing Unit (GPU), an Application Specific Integrated Circuit (ASI), and/or a Field Programmable Gate Array (FPGA). Notably, the first 102 and/or second 104 computing devices may be the storage controller of a data storage media (e.g., the controller for a hard disk drive) such that data delivered to/from the data storage media is always encrypted so as to limit the ability of an attacker to ever have access to unencrypted data. Embodiments may be provided as a computer program product which may include a computer-readable, or machine-readable, medium having stored thereon instructions which may be used to program/operate a computer (or other electronic devices) or computer system to perform a process or processes in accordance with the various embodiments. The computer-readable medium may include, but is not limited to, hard disk drives, floppy diskettes, optical disks, Compact Disc Read-Only Memories (CD-ROMs), Digital Versatile Disc ROMS (DVD-ROMs), Universal Serial Bus (USB) memory sticks, magneto-optical disks, ROMs, random access memories (RAMs), Erasable Programmable ROMs (EPROMs), Electrically Erasable Programmable ROMs (EEPROMs), magnetic optical cards, flash memory, or other types of media/machine-readable medium suitable for storing electronic instructions. The computer program instructions may reside and operate on a single computer/electronic device or various portions may be spread over multiple computers/devices that comprise a computer system. Moreover, embodiments may also be downloaded as a computer program product, wherein the program may be transferred from a remote computer to a requesting computer by way of data signals embodied in a carrier wave or other propagation medium via a communication link (e.g., a modem or network connection, including both wired/cabled and wireless connections).

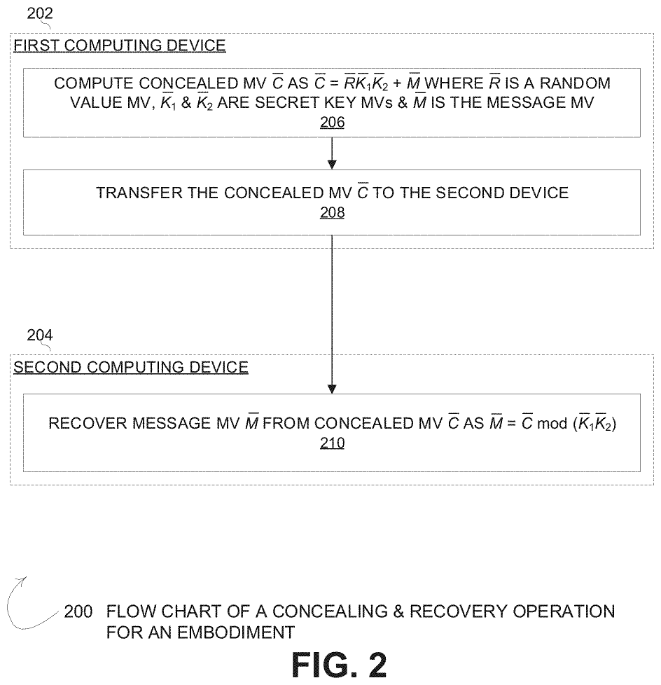

### Operational Flow Chart for Concealing and Recovery for an Embodiment (FIG. 2)

FIG. 2 is a flow chart 200 a concealing and recovery operation for an embodiment. At process 206, the first computing device 202 (i.e., the first device 206) computes a concealed multivector (C̅) as a function of (C̅=R̅K̅₁K̅₂+M̅). All of the multivectors are in the [symbol] ³ space and are invertible. The R̅ multivector is a random multivector with random coefficients. The K̅₁ and K̅₂ multivectors are the secret key multivectors that are known to both the first computing device 202 and the second computing device 204, but not to other devices. The message multivector M̅ is the multivector being concealed in process 206. At process 208, the first computing device 202 transfers the concealed multivector (C̅) to the second computing device 204. At process 210, the second computing device 204 recovers the message multivector M̅ from the concealed multivector (C̅) as a function of (M̅=C̅ mod(K̅₁K̅₂)).

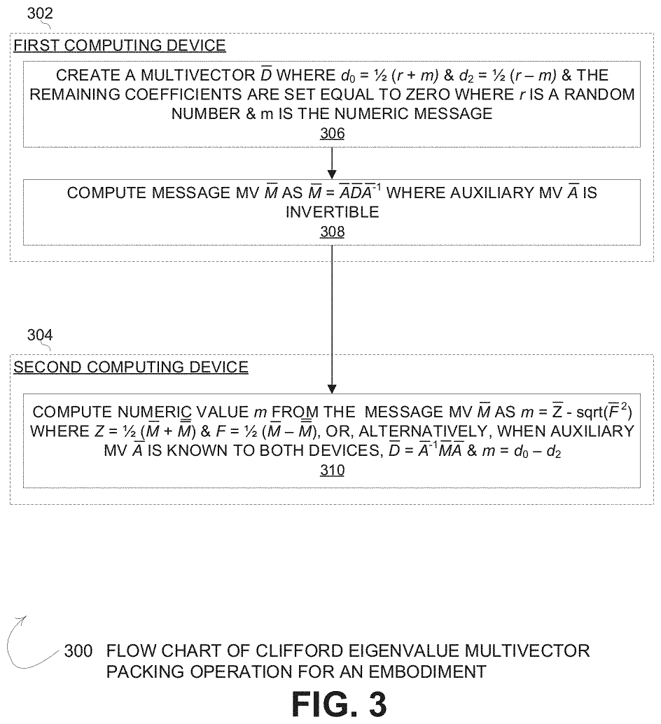

### Operational Flow Chart for Clifford Eigenvalue Multivector Packing for an Embodiment (FIG. 3)

FIG. 3 is a flow chart 300 of Clifford eigenvalue multivector packing operation for an embodiment. At process 306, the first computing device 302 creates a multivector D where the d₀ coefficient is defined by as d₀=½(r+m) and the d₂ coefficient is defined as d₂=½(r−m). The remaining coefficients of multivector D are set to zero (i.e., d₁=d₃=d₁₂=d₁₃=d₂₃=d₁₂₃=0). The value r is a random number and m is the numeric message that is to be represented by the message multivector M̅. At process 308, the first computing device 302 computes the message multivector M̅ as M̅=ĀD̅Ā⁻¹ where a rationalize of the auxiliary multivector Ā does not equal zero (R(Ā)≠0) such that ĀĀ⁻¹=1 and auxiliary multivector Ā is, accordingly, invertible. At process 310, the second computing device 304 computes the number value m as m=Z̅−F̅²̅ where eigenvalue multivector Z̅ is Z̅=½(M̅+M̅) and eigenvalue multivector F̅ is F̅=½(M̅−M̅). Alternatively, when the auxiliary multivector Ā is known to both computing devices 302, 304, at process 310, the second computing device 304 may compute the multivector D from the message multivector M̅ as D̅=Ā⁻¹M̅Ā and then simply compute the numeric message value m from the d₀ and d₂ coefficients of the multivector D̅ as m=d₀−d₂.

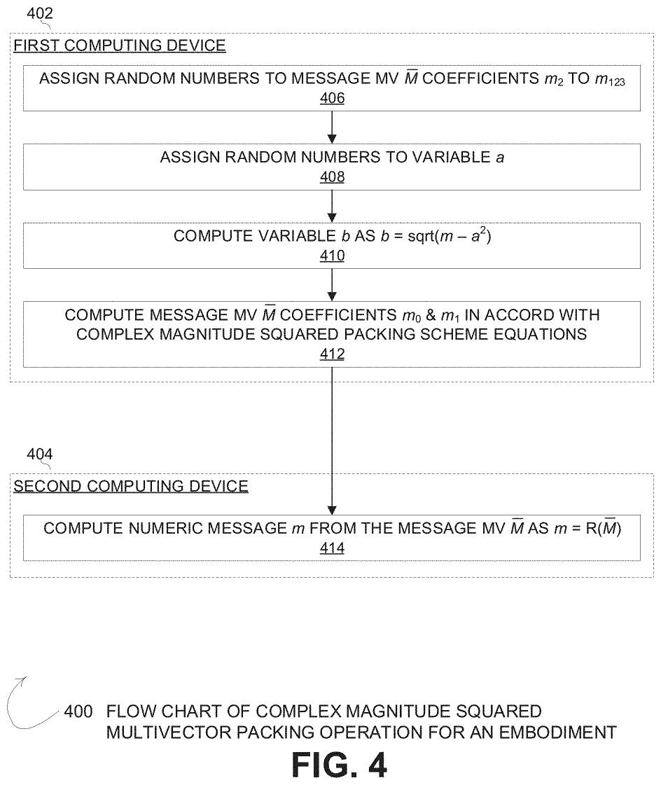

### Operational Flow Chart for Complex Magnitude Squared Multivector Packing for an Embodiment (FIG. 4)

FIG. 4 is a flow chart 400 of complex magnitude squared multivector packing operation for an embodiment. At process 406, the first computing device 402 assigns random numbers to the message multivector M̅ coefficients m₂ to m₁₂₃ (i.e., m₂, m₃, m₁₂, m₁₃, m₂₃, m₁₂₃). At process 408, the first computing device 402 assigns a random number to the a variable. At process 410, the first computing device 402 computes variable b as b=\sqrt{m−a²}. At process 412, the first computing device 402 computes the m₀ and m₁ coefficients of message multivector M as a function of the b variable and m₂ to m₁₂₃ coefficients of message multivector M̅ in accord with the complex magnitude squared packing scheme equations disclosed in more detail above and reiterated below:

m₀=x₁−(x₂(x₃+x₄\sqrt{x₅}+x₆))/x₇,

m₁=−(x₃+x₄\sqrt{x₅}+x₆)/x₈,

x₁=(b−2m₂m₁₃+2m₃m₁₂)/(2m₁₂₃),

x₂=m₂₃,

x₃=bm₂₃,

x₄=2m₁₂₃,

x₅=(τ+μ+ν+ω),

x₆=(−2m₂m₁₃m₂₃+2m₃m₁₂m₂₃),

x₇=(2m₁₂₃(m₂₃+m₁₂₃)(m₂₃−m₁₂₃)),

x₈=(2(m₂₃+m₁₂₃)(m₂₃−m₁₂₃)),

τ=b²−4bm₂m₁₃+4bm₃m₁₂+4m₂²m₁₃²+4m₂²m₂₃²,

μ=−4m₂²m₁₂₃²−8m₂m₃m₁₂m₁₃+4m₃²m₁₂²+4m₃²m₂₃²−4m₃²m₁₂₃²,

ν=−4m₁₂²m₂₃²+4m₁₂²m₁₂₃²−4m₁₃²m₂₃²+4m₁₃²m₁₂₃²−4m₂₃⁴, and,

ω=8m₂₃²m₁₂₃²+4am₂₃²−4m₁₂₃⁴−4am₁₂₃⁴.

At process 414, the second computing device 404 computes the numeric message value m from the message multivector M̅ as a rationalize of message multivector M̅ such that m=R(M̅).

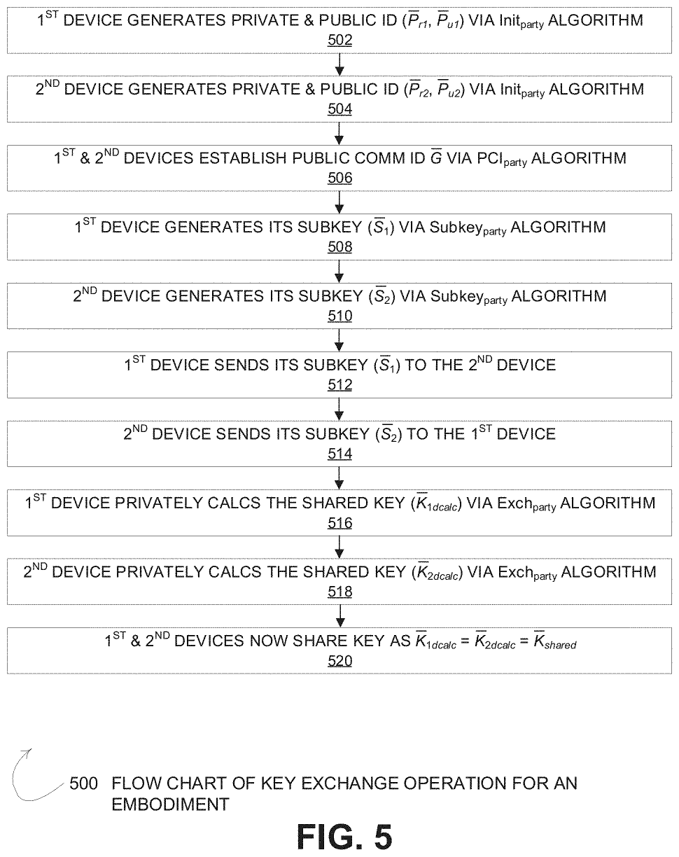

### Operational Flow Chart for Key Exchange Operation for an Embodiment (FIG. 5)

FIG. 5 is a flow chart 500 of key exchange operation for an embodiment. At process 502, the first device generates its private and public identification information via algorithm Init_{party}. A first private ID multivector (P̅ᵣ_{₁}) is obtained as a random multivector via algorithm RandMult_{mod} and a first public ID multivector (P̅ᵤ_{₁}) as a random multivector via algorithm RandMultNI_{mod} such that coefficients of both the first private ID multivector (P̅ᵣ_{₁}) and the first public ID multivector (P̅ᵤ_{₁}) are reduced by a modulus q for q a positive integer and such that the first public ID multivector (P̅ᵤ_{₁}) is non-invertible. At process 504, the second device generates its private and public identification information via algorithm Init_{party}. A second private ID multivector (P̅ᵣ_{₂}) is obtained as a random multivector via algorithm RandMult_{mod} and a second public ID multivector (P̅ᵤ_{₂}) as a random multivector via algorithm RandMultNI_{mod} such that coefficients of both the second private ID multivector (P̅ᵣ_{₂}) and the second public ID multivector (P̅ᵤ_{₂}) are reduced by a modulus q for q a positive integer and such that the second public ID multivector (P̅ᵤ_{₂}) is non-invertible. At process 506, both the first and second devices establish a public communication ID multivector (G̅) via algorithm PCI_{party} as a Geometric Algebra product operation of the first public ID multivector (P̅ᵤ_{₁}) and the second public ID multivector (P̅ᵤ_{₂}) (G̅=P̅ᵤ_{₁},P̅ᵤ_{₂}). At process 508, the first device generates its subkey multivector (S̅₁) via algorithm Subkey_{party} as a Geometric Product operation of the first private ID multivector (P̅ᵣ_{₁}) and the public communication identifier multivector (G̅) (S̅₁=P̅ᵣ_{₁}G̅). At process 510, the second device generates its subkey multivector (S̅₂) via algorithm Subkey_{party} as a Geometric Product operation of the public communication identifier multivector (G̅) and the second private ID multivector (P̅ᵣ_{₂}) (S̅₂=G̅P̅ᵣ_{₂}). At process 512, the first device sends its subkey multivector (S̅₂) to the second device. At process 514, the second device sends its subkey multivector (S̅₂) to the first device.

At process 516, the first device privately generates at least one shared secret key (K̅_{shared}) as a first device calculated shared secret key (K̅_{1dcalc}) via algorithm Exch_{party} as a Geometric Product operation of the first private ID multivector (P̅ᵣ_{₁}), the second subkey multivector (S̅₂) and the public communication identifier multivector (G̅) plus the public communication identifier multivector (G̅) plus 1 (K_{1dcalc}=P̅ᵣ_{₁}S̅₂G̅+G̅+1)=K̅_{shared}). At process 518, the second device privately generates the at least one shared secret key (K̅_{shared}) as a second device calculated shared secret key (K̅_{2dcalc}) via the algorithm Exch_{party}, as a Geometric Product operation of the first subkey multivector (S̅₁), the second private ID multivector (P̅ᵣ_{₂}) and the public communication identifier multivector (G̅) plus the public communication identifier multivector (G̅) plus 1 (K̅_{2dcalc}=S̅₁P̅ᵣ_{₂}G̅+G̅+1)=K̅_{shared}). At process 520, the first and second devices now share a security (K̅_{shared}) such that the first device calculated shared secret key (K̅_{1dcalc}) and the second device calculated shared secret key (K̅_{2dcalc}) equal each other to establish the at least one shared secret key (K̅_{1dcalc}=K̅_{2dcalc}=K̅_{shared}).

The foregoing description of the invention has been presented for purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated.

What is claimed is:

1. A method for concealing a message multivector (M̅) with Modular Concealment (MC) utilizing a secret key comprised of two secret key multivectors (K̅₁,K̅₂) and a random multivector (R) transferred between a first device and a second device wherein said multivectors are members of a 3-dimensional Geometric Algebra product space ( [symbol] ³), said multivectors are invertible, and said two secret key multivectors (K̅₁,K̅₂) are known to both said first and second devices, the method comprising:
computing by a first device a concealed multivector (C̅) as a Geometric Algebra product operation of said random multivector (R̅), said first multivector (K̅₁) and said second multivector (K̅₂) added to said message multivector (M̅) (C̅=R̅K̅₁K̅₂+M̅);
transferring by said first device said concealed multivector (C̅) to said second device; and,
computing by said second device a recovery of said concealed multivector (C̅) back into said message multivector (M̅) as a modulus operation on said concealed multivector (C̅) of said Geometric Algebra product operation of said first multivector (K̅₁) and said second multivector (K̅₂) (M̅=C̅ mod(K̅₁K̅₂)).

2. The method of claim 1 wherein said concealed multivector (C̅) is homomorphic with respect to addition and multiplication.

3. The method of claim 1 wherein said message multivector (M̅) is a data representation of a numeric message (m) based on a multivector packing scheme such that said multivector packing scheme is a Clifford Eigenvalue Packing Scheme (CEP), and wherein the method of claim 1 further comprises:
creating by said first device a multivector D̅ such that a do coefficient of said multivector D̅ equals one half of a total of a random number r plus said numeric message m (d₀=½(r+m)), a d₂ coefficient of said multivector b equals one half of a total of said random number r said minus numeric message m (d₂=½(r−m)), and all other coefficients of said multivector D̅ equal zero (d₁=d₃=d₁₂=d₁₃=d₂₃=d₁₂₃=0) where said random number r is greater than said numeric message m;
computing by said first device said message multivector M̅ as a Geometric Algebra product operation of an auxiliary multivector Ā, said multivector D, and an inverse of said auxiliary multivector Ā⁻¹ (M̅=ĀD̅Ā⁻¹) where a rationalize of said auxiliary multivector does not equal 0 (R(Ā)≠0) such that a Geometric Algebra product operation of said auxiliary multivector Ā and said inverse of said auxiliary multivector Ā⁻¹ equals 1 (ĀĀ⁻¹=1) and auxiliary multivector Ā is, accordingly, invertible; and,
computing by said second device numeric message m from said message multivector M̅ recovered by said second device as eigenvalue multivector Z̅ minus the square root of eigenvalue multivector F̅ squared (m=Z̅−\sqrt{F̅²}) where said eigenvalue multivector Z̅ is equal to one half of a total of said message multivector M̅ plus a Clifford conjugate of said message multivector M̅ (Z̅=½(M̅+M̅)) and said eigenvalue multivector F̅ is equal to one half of a total of said message multivector M̅ minus said Clifford conjugate of said message multivector M̅ (F̅=½(M̅−M̅)).

4. The method of claim 1 wherein said message multivector (M̅) is a data representation of a numeric message (m) based on a multivector packing scheme such that said multivector packing scheme is an alternative Clifford Eigenvalue Packing Scheme (CEP), and wherein the method of claim 1 further comprises:
creating by said first device a multivector D̅ such that a do coefficient of said multivector D̅ equals one half of a total of a random number r plus said numeric message m (d₀=½(r+m)), a d₂ coefficient of said multivector D̅ equals one half of a total of said random number r said minus numeric message m (d₂=½(r−m)), and all other coefficients of said multivector D equal zero (d₁=d₃=d₁₂=d₁₃=d₂₃=d₁₂₃=0) where said random number r is greater than said numeric message m;
computing by said first device said message multivector M̅ as a Geometric Algebra product operation of an auxiliary multivector Ā, said multivector D, and an inverse of said auxiliary multivector Ā⁻¹ (M̅=ĀD̅Ā⁻¹) where a rationalize of said auxiliary multivector does not equal 0 (R(Ā)≠0) such that a Geometric Algebra product operation of said auxiliary multivector Ā and said inverse of said auxiliary multivector Ā⁻¹ equals 1 (ĀĀ⁻¹=1) and auxiliary multivector Ā is, accordingly, invertible, and wherein said auxiliary multivector Ā is known to both of said first and second devices; and,
computing by said second device numeric message m from said message multivector M̅ recovered by said second device by computing said multivector D̅ as a Geometric Product operation of said inverse of said auxiliary multivector Ā⁻¹, said message multivector M̅, and said auxiliary multivector Ā (D̅=Ā⁻¹M̅Ā) and then computing numeric message m as said do coefficient of said multivector D̅ minus said d2 coefficient of said multivector D̅ (m=d₀−d₂).

5. The method of claim 1 wherein said message multivector (M̅) is a data representation of a numeric message (m) based on a multivector packing scheme such that said multivector packing scheme is a Complex Magnitude Squared Packing Scheme (CMSP), and wherein the method of claim 1 further comprises:
assigning by said first device random numbers to coefficients from m₂ to m₁₂₃ (m₂, m₃, m₁₂, m₁₃, m₂₃, m₁₂₃) of said message multivector M̅;
assigning by said first device a random number to a variable a;
computing by said first device a variable b as the square root of a sum of said numeric message m minus said variable a squared (b=\sqrt{m−a²});
computing by said first device a m₀ coefficient of said message multivector M̅ and a m₁ coefficient of said message multivector M̅ as a function of said m₂ to m₁₂₃ coefficients of said message multivector M̅ and said variable b in accord with the following equations:
m₀=x₁−(x₂(x₃+x₄\sqrt{x₅}+x₆))/x₇,
m₁=−(x₃+x₄\sqrt{x₅}+x₆)/x₈,
x₁=(b−2m₂m₁₃+2m₃m₁₂)/(2m₁₂₃),
x₂=m₂₃,
x₃=bm₂₃,
x₄=2m₁₂₃,
x₅=(τ+μ+ν+ω),
x₆=(−2m₂m₁₃m₂₃+2m₃m₁₂m₂₃),
x₇=(2m₁₂₃(m₂₃+m₁₂₃)(m₂₃−m₁₂₃)),
x₈=(2(m₂₃+m₁₂₃)(m₂₃−m₁₂₃)),
τ=b²−4bm₂m₁₃+4bm₃m₁₂+4m₂²m₁₃²+4m₂²m₂₃²,
μ=−4m₂²m₁₂₃²−8m₂m₃m₁₂m₁₃+4m₃²m₁₂²+4m₃²m₂₃²−4m₃²m₁₂₃²,
ν=−4m₁₂²m₂₃²+4m₁₂²m₁₂₃²−4m₁₃²m₂₃²+4m₁₃²m₁₂₃²−4m₂₃⁴, and,
ω=8m₂₃²m₁₂₃²+4am₂₃²−4m₁₂₃⁴−4am₁₂₃⁴; and
computing by said second device said numeric message m from said message multivector M̅ recovered by said second device as a Geometric Algebra rationalize operation on said message multivector M̅ (m=R(M̅)).

6. The method of claim 1 wherein at least one shared secret key (K̅_{shared}) of said two secret key multivectors (K̅₁,K̅₂) is derived and exchanged through a Key Exchange protocol, and wherein the method of claim 1 further comprises:
generating first device identification by said first device via algorithm Init_{party} to obtain a first private ID multivector (P̅ᵣ_{₁}) as a random multivector via algorithm RandMult_{mod} and a first public ID multivector (P̅ᵤ_{₁}) as a random multivector via algorithm RandMultNI_{mod} such that coefficients of both said first private ID multivector (P̅ᵣ_{₁}) and said first public ID multivector (P̅ᵤ_{₁}) are reduced by a modulus q for q a positive integer and such that said first public ID multivector (P̅ᵤ_{₁}) is non-invertible;
generating second device identification by said second device via said algorithm Init_{party} to obtain a second private ID multivector (P̅ᵣ_{₂}) as a random multivector via said algorithm RandMult_{mod} and a second public ID multivector (P̅ᵤ_{₂}) as a random multivector via said algorithm RandMultNI_{mod} such that coefficients of both said second private ID multivector (P̅ᵣ_{₂}) and said second public ID multivector (P̅ᵤ_{₂}) are reduced by said modulus q for q a positive integer and such that said second public ID multivector (P̅ᵤ_{₂}) is non-invertible;
establishing by both said first and second devices a public communication identifier multivector (G̅) via algorithm PCI_{party} as a Geometric Algebra product operation of said first public ID multivector (P̅ᵤ_{₁}) and said second public ID multivector (P̅ᵤ_{₁}) (G̅=P̅ᵤ_{₁}P̅ᵤ_{₂});
generating by said first device a first subkey multivector (S̅₁) via algorithm Subkey_{party} as a Geometric Product operation of said first private ID multivector (P̅ᵣ_{₁}) and said public communication identifier multivector (G̅) (S₁=P̅ᵣ_{₁}G̅);
generating by said second device a second subkey multivector (S̅₂) via said algorithm Subkey_{party} as a Geometric Product operation of said public communication identifier multivector (G̅) and said second private ID multivector (P̅ᵣ_{₂}) (S̅₂=G̅P̅ᵣ_{₂});
sending by said first device said first subkey multivector (S̅₁) to said second device;
sending by said second device said second subkey multivector (S̅₂) to said second device;
generating privately by said first device said at least one shared secret key (K̅_{shared}) as a first device calculated shared secret key (K̅_{1dcalc}) via algorithm Exch_{party} as a Geometric Product operation of said first private ID multivector (P̅ᵣ_{ᵢ}), said second subkey multivector (S̅₂) and said public communication identifier multivector (G̅) plus said public communication identifier multivector (G̅) plus 1 (K̅_{1dcalc}=P̅ᵣ_{₁}S̅₂G̅+G̅+1)=K̅_{shared}); and,
generating privately by said second device said at least one shared secret key (K̅_{shared}) as a second device calculated shared secret key (K̅_{2dcalc}) via said algorithm Exch_{party} as a Geometric Product operation of said first subkey multivector (S̅₁), said second private ID multivector (P̅ᵣ_{₂}) and said public communication identifier multivector (G̅) plus said public communication identifier multivector (G̅) plus 1 (K̅_{2dcalc}=S̅₁P̅ᵣ_{₂}G̅+G̅+1)=K̅_{shared}) such that said first device calculated shared secret key (K_{1dcalc}) and said second device calculated shared secret key (K̅_{2dcalc}) equal each other to establish said at least one shared secret key (K̅_{1dcalc}=K̅_{2dcalc}=K̅_{shared}).

7. A data concealment system for concealment of a message multivector (M̅) with Modular Concealment (MC) utilizing a secret key comprised of two secret key multivectors (K̅₁,K̅₂) and a random multivector (R) that is transferred between a first device and a second device wherein said multivectors are members of a 3-dimensional Geometric Algebra product space ( [symbol] ³), said multivectors are invertible, and said two secret key multivectors (K̅₁,K̅₂) are known to both said first and second devices, the method comprising:
said first device, wherein said first device further comprises:
a concealed multivector computation subsystem that computes a concealed multivector (C̅) as a Geometric Algebra product operation of said random multivector (R̅), said first multivector (K̅₁) and said second multivector (K̅₂) added to said message multivector (M̅) (C̅=R̅K̅₁K̅₂+M̅); and
a conceal multivector transfer subsystem that transfers said concealed multivector (C̅) to said second device; and
said second device, wherein said second device further comprises:
a message multivector recovery computation subsystem that computes a recovery of said concealed multivector (C̅) back into said message multivector (M̅) as a modulus operation on said concealed multivector (C̅) of said Geometric Algebra product operation of said first multivector (K̅₁) and said second multivector (K̅₂) (M̅=C̅ mod(K̅₁K̅₂)).

8. The data concealment system of claim 7 wherein said concealed multivector (C̅) is homomorphic with respect to addition and multiplication.

9. The data concealment system of claim 7 wherein said message multivector (M̅) is a data representation of a numeric message (m) based on a multivector packing scheme such that said multivector packing scheme is a Clifford Eigenvalue Packing Scheme (CEP),
wherein said first device further comprises:
a D multivector creation subsystem that creates a multivector D̅ such that a d₀ coefficient of said multivector D̅ equals one half of a total of a random number r plus said numeric message m (d₀=½(r+m)), a d₂ coefficient of said multivector D̅ equals one half of a total of said random number r said minus numeric message m (d₂=½(r−m)), and all other coefficients of said multivector D̅ equal zero (d₁=d₃=d₁₂=d₁₃=d₂₃=d₁₂₃=0) where said random number r is greater than said numeric message m; and,
a message multivector computation subsystem that computes said message multivector M̅ as a Geometric Algebra product operation of an auxiliary multivector Ā, said multivector D̅, and an inverse of said auxiliary multivector Ā⁻¹ (M̅=ĀD̅Ā⁻¹) where a rationalize of said auxiliary multivector does not equal 0 (R(Ā)≠0) such that a Geometric Algebra product operation of said auxiliary multivector Ā and said inverse of said auxiliary multivector Ā⁻¹ equals 1 (ĀĀ⁻¹=1) and auxiliary multivector Ā is, accordingly, invertible; and,
wherein said second device further comprises:
a numeric message computation subsystem that computes said numeric message m from said message multivector M̅ recovered by said second device as eigenvalue multivector Z̅ minus the square root of eigenvalue multivector F̅ squared (m=Z̅−\sqrt{F̅²}) where said eigenvalue multivector Z̅ is equal to one half of a total of said message multivector M̅ plus a Clifford conjugate of said message multivector M̅ (Z̅=½(M̅+M̅)) and said eigenvalue multivector F̅ is equal to one half of a total of said message multivector M̅ minus said Clifford conjugate of said message multivector M̅ (F̅=½(M̅−M̅)).

10. The data concealment system of claim 7 wherein said message multivector (M̅) is a data representation of a numeric message (m) based on a multivector packing scheme such that said multivector packing scheme is an alternative Clifford Eigenvalue Packing Scheme (CEP),
wherein said first device further comprises:
a D multivector creation subsystem that creates a multivector D̅ such that a d₀ coefficient of said multivector D̅ equals one half of a total of a random number r plus said numeric message m (d₀=½(r+m)), a d₂ coefficient of said multivector D̅ equals one half of a total of said random number r said minus numeric message m (d₂=½(r−m)), and all other coefficients of said multivector D̅ equal zero (d₁=d₃=d₁₂=d₁₃=d₂₃=d₁₂₃=0) where said random number r is greater than said numeric message m; and,
a message multivector computation subsystem that computes said message multivector M̅ as a Geometric Algebra product operation of an auxiliary multivector Ā, said multivector D̅, and an inverse of said auxiliary multivector Ā⁻¹ (M̅=ĀD̅Ā⁻¹) where a rationalize of said auxiliary multivector does not equal 0 (R(Ā)≠0) such that a Geometric Algebra product operation of said auxiliary multivector Ā and said inverse of said auxiliary multivector Ā⁻¹ equals 1 (ĀĀ⁻¹=1) and auxiliary multivector Ā is, accordingly, invertible, and wherein said auxiliary multivector Ā is known to both of said first and second devices; and,
wherein said second device further comprises:
a numeric message computation subsystem that computes said numeric message m from said message multivector M̅ recovered by said second device by computing said multivector D̅ as a Geometric Product operation of said inverse of said auxiliary multivector Ā⁻¹, said message multivector M̅, and said auxiliary multivector Ā (D̅=Ā⁻¹M̅Ā) and then computing numeric message m as said do coefficient of said multivector D̅ minus said d2 coefficient of said multivector D̅ (m=d₀−d₂).

11. The data concealment system of claim 7 wherein said message multivector (M̅) is a data representation of a numeric message (m) based on a multivector packing scheme such that said multivector packing scheme is a Complex Magnitude Squared Packing Scheme (CMSP),
wherein said first device further comprises:
a message multivector random coefficient assignment subsystem that assigns random numbers to coefficients from m₂ to m₁₂₃ (m₂, m₃, m₁₂, m₁₃, m₂₃, m₁₂₃) of said message multivector M̅;
a variable a random assignment subsystem that assigns a random number to a variable a;
a variable b computation subsystem that computes a variable b as the square root of a sum of said numeric message m minus said variable a squared (b=\sqrt{m−a²});
a message multivector coefficient computation subsystem that computes a m₀ coefficient of said message multivector M̅ and a m₁ coefficient of said message multivector M̅ as a function of said m₂ to m₁₂₃ coefficients of said message multivector M̅ and said variable b in accord with the following equations:
m₀=x₁−(x₂(x₃+x₄\sqrt{x₅}+x₆))/x₇,
m₁=−(x₃+x₄\sqrt{x₅}+x₆)/x₈,
x₁=(b−2m₂m₁₃+2m₃m₁₂)/(2m₁₂₃),
x₂=m₂₃,
x₃=bm₂₃,
x₄=2m₁₂₃,
x₅=(τ+μ+ν+ω),
x₆=(−2m₂m₁₃m₂₃+2m₃m₁₂m₂₃),
x₇=(2m₁₂₃(m₂₃+m₁₂₃)(m₂₃−m₁₂₃)),
x₈=(2(m₂₃+m₁₂₃)(m₂₃−m₁₂₃)),
τ=b²−4bm₂m₁₃+4bm₃m₁₂+4m₂²m₁₃²+4m₂²m₂₃²,
μ=−4m₂²m₁₂₃²−8m₂m₃m₁₂m₁₃+4m₃²m₁₂²+4m₃²m₂₃²−4m₃²m₁₂₃²,
ν=−4m₁₂²m₂₃²+4m₁₂²m₁₂₃²−4m₁₃²m₂₃²+4m₁₃²m₁₂₃²−4m₂₃⁴, and,
ω=8m₂₃²m₁₂₃²+4am₂₃²−4m₁₂₃⁴−4am₁₂₃⁴; and
wherein said second device further comprises:
a numeric message computation subsystem that computes said numeric message m from said message multivector M̅ recovered by said second device as a Geometric Algebra rationalize operation on said message multivector M̅ (m=R(M̅)).

12. The data concealment system of claim 7 wherein at least one shared secret key (K̅_{shared}) of said two secret key multivectors (K̅₁,K̅₂) is derived and exchanged through a Key Exchange protocol,
wherein said first device further comprises:
a first device ID generation subsystem that generates a first device identification via algorithm Init_{party} to obtain a first private ID multivector (P̅ᵣ_{₁}) as a random multivector via algorithm RandMult_{mod} and a first public ID multivector (P̅ᵤ_{₁}) as a random multivector via algorithm RandMultNI_{mod} such that coefficients of both said first private ID multivector (P̅ᵣ_{₁}) and said first public ID multivector (P̅ᵤ_{₁}) are reduced by a modulus q for q a positive integer and such that said first public ID multivector (P̅ᵤ_{₁}) is non-invertible;
a first device public identifier multivector establishment subsystem that establishes a public communication identifier multivector (G̅) via algorithm PCI_{party} as a Geometric Algebra product operation of said first public ID multivector (P̅ᵤ_{₁}) and said second public ID multivector (P̅ᵤ_{₂}) (G̅=P̅ᵤ_{₁}P̅ᵤ_{₂});
a first subkey multivector generation subsystem that generates a first subkey multivector (S̅₁) via algorithm Subkey_{party} as a Geometric Product operation of said first private ID multivector (P̅ᵣ_{₁}) and said public communication identifier multivector (G̅) (S̅₁=P̅ᵣ_{₁}G̅);
a first subkey delivery subsystem that sends said first subkey multivector (S̅₁) to said second device; and
a first device shared key subsystem that privately generates said at least one shared secret key (K̅_{shared}) as a first device calculated shared secret key (K̅_{1dcalc}) via algorithm Exch_{party} as a Geometric Product operation of said first private ID multivector (P̅ᵣ_{₁}), said second subkey multivector (S̅₂) and said public communication identifier multivector (G̅) plus said public communication identifier multivector (G̅) plus 1 (K̅_{1dcalc}=P̅ᵣ_{₁}S̅₂G̅+G̅+1)=K̅_{shared}); and,
wherein said second device further comprises:
a second device ID generation subsystem that generates second device identification via said algorithm Init_{party} to obtain a second private ID multivector (P̅ᵣ_{₂}) as a random multivector via said algorithm RandMult_{mod} and a second public ID multivector (P̅ᵤ_{₂}) as a random multivector via said algorithm RandMultNI_{mod} such that coefficients of both said second private ID multivector (P̅ᵣ_{₂}) and said second public ID multivector (P̅ᵤ_{₂}) are reduced by said modulus q for q a positive integer and such that said second public ID multivector (P̅ᵤ_{₂}) is non-invertible;
a second device public identifier multivector establishment subsystem that establishes said public communication identifier multivector (G̅) via said algorithm PCI_{party} as said Geometric Algebra product operation of said first public ID multivector (P̅ᵤ_{₁}) and said second public ID multivector (P̅ᵤ_{₂}) (G̅=P̅ᵤ_{₁}P̅ᵤ_{₂});
a second subkey multivector generation subsystem that generates a second subkey multivector (S̅₂) via said algorithm Subkey_{party} as a Geometric Product operation of said public communication identifier multivector (G̅) and said second private ID multivector(P̅ᵣ_{₂}) (S̅₂=G̅P̅ᵣ_{₂});
a second subkey delivery subsystem that sends said second subkey multivector (S̅₂) to said second device;
a second device shared key subsystem that privately generates said at least one shared secret key (K_{shared}) as a second device calculated shared secret key (K̅_{2dcalc}) via said algorithm Exch_{party} as a Geometric Product operation of said first subkey multivector (S̅₁), said second private ID multivector (P̅ᵣ_{₂}) and said public communication identifier multivector (G̅) plus said public communication identifier multivector (G̅) plus 1 (K̅_{2dcalc}=S̅₁P̅ᵣ_{₂}G̅+G̅+1)=K̅_{shared}) such that said first device calculated shared secret key (K̅_{1dcalc}) and said second device calculated shared secret key (K_{2dcalc}) equal each other to establish said at least one shared secret key (K̅_{1dcalc}=K̅_{2dcalc}=K̅_{shared}).
